(19) United States
(12) Patent Application Publication
(10) Pub. No.: US 2025/0301395 A1
(43) Pub. Date: Sep. 25, 2025

(54) ON-DEMAND SSB FOR NES CELLS

(71) Applicant: QUALCOMM Incorporated, San Diego, CA (US)

(72) Inventors: Jianghong LUO, Skillman, NJ (US); Navid ABEDINI, Basking Ridge, NJ (US)

(21) Appl. No.: 18/611,616

(22) Filed: Mar. 20, 2024

(51) Int. Cl. H04W 48/08; H04W 52/02; H04W 64/00

(52) U.S. Cl. CPC H04W 48/08; H04W 52/0235; H04W 64/00

(57) ABSTRACT

On-demand SSB transmissions for NES cells based on location information is described. An apparatus is configured to obtain location information associated with a UE and detect a condition is met based on the location information. The condition is associated with a parameter-based relationship of the UE to a first network node. The apparatus is configured to transmit, based on the condition, an indication associated with activation or deactivation of SSB transmissions at the first or a second network node. Another apparatus is configured to select a sleep state configuration associated with power or latency for a sleep state for a second network node. The apparatus is configured to transmit, to the second network node based on the sleep state configuration, an indication for activation or deactivation of SSB transmissions at the second network node. The indication is indicative of sleep state information associated with the sleep state and the deactivation.

### TECHNICAL FIELD

The present disclosure relates generally to communication systems, and more particularly, to wireless communications utilizing network energy savings (NES) cells.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at/by a UE. The apparatus is configured to obtain location information associated with the UE. The apparatus is also configured to detect, based on the location information associated with the UE, that a condition is met, where the condition is associated with a parameter-based relationship of the UE to a first network node. The apparatus is also configured to transmit, based on the condition being met, an indication associated with an activation or a deactivation of a set of synchronization signal block (SSB) transmissions at one or more of the first network node or a second network node.

In the aspect, the method includes obtaining location information associated with the UE. The method also includes detecting, based on the location information associated with the UE, that a condition is met, where the condition is associated with a parameter-based relationship of the UE to a first network node. The method also includes transmitting, based on the condition being met, an indication associated with an activation or a deactivation of a set of SSB transmissions at one or more of the first network node or a second network node.

In another aspect of the disclosure, a method, a computer-readable medium, and an apparatus are provided. The apparatus is configured to select a sleep state configuration, where the sleep state configuration is associated with at least one of a power or a latency for a sleep state for a second network node. The apparatus is also configured to transmit, to the second network node and based on the sleep state configuration, an indication associated with an activation or a deactivation of a set of SSB transmissions at the second network node, where the indication is indicative of sleep state information associated with the sleep state and the deactivation.

In the aspect, the method includes selecting a sleep state configuration, where the sleep state configuration is associated with at least one of a power or a latency for a sleep state for a second network node. The method also includes transmitting, to the second network node and based on the sleep state configuration, an indication associated with an activation or a deactivation of a set of SSB transmissions at the second network node, where the indication is indicative of sleep state information associated with the sleep state and the deactivation.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a configuration for an anchor cell with network energy savings (NES) cells.

FIG. 5 is a diagram illustrating an example of an SSB configuration for a NES cell of an anchor cell.

FIG. 6 is a diagram illustrating an example of an SSB configuration for a NES cell of an anchor cell.

FIG. 7 is a call flow diagram for wireless communications, in accordance with various aspects of the present disclosure.

FIG. 8 is a call flow diagram for wireless communications, in accordance with various aspects of the present disclosure.

FIG. 9 is a call flow diagram for wireless communications, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

Wireless communication networks may be designed to support communications between network nodes (e.g., base stations, gNBs, etc.) and UEs. For instance, a network node and a UE in a wireless communication network may communicate in various configurations and using various communication schema to conserve power and energy in the network. One example communication scheme to conserve network energy utilizes an NES cell(s) for on-demand SSB transmission for secondary cell (SCell) for connected UEs. In such solutions, triggering methods for on-demand SSB transmission may be utilized (e.g., a UE UL wake-up signal using an existing signal/channel, cell on/off indications via backhaul, SCell activation/deactivation signaling, etc.).

However, as NES cells are within the coverage area of an anchor cell and may be added as SCells for connected UEs, energy savings issues may arise due to the lack of support for idle UEs. That is, when idle UEs, or no UEs, are within the range of an NES cell, the NES cell may continue to provide SSB transmissions and expend network power/energy. Further to this issue, without SSB transmissions from an NES cell, there is no measurement between the NES and a UE to discover whether the UE is within cell coverage of the NES cell.

Various aspects relate generally to wireless communications utilizing NES cells. Some aspects more specifically relate to on-demand SSB transmissions for NES cells based on location information. In some examples, a UE obtains location information associated with the UE, and detects, based on the location information associated with the UE, that a condition is met. The condition may be associated with a parameter-based relationship of the UE to a first network node, such as an NES node/cell. The UE then transmits, based on the condition being met, an indication associated with an activation or a deactivation of SSB transmissions at one or more of the first network node or a second network node, such as a base station, gNB, etc. In some examples, a first network node, such as a base station, gNB, CU, etc., selects a sleep state configuration. The sleep state configuration may be associated with at least one of a power or a latency for a sleep state for a second network node, such as an NES node/cell. The first network node transmits, to the second network node and based on the sleep state configuration, an indication associated with an activation or a deactivation of SSB transmissions at the second network node. The indication may be indicative of sleep state information associated with the sleep state and the deactivation.

Particular aspects of the subject matter described in this disclosure can be implemented to realize one or more of the following potential advantages. In some examples, by obtaining location information associated with a UE, e.g., from the UE or an anchor node, the described techniques can be used to enable the dynamic activation/deactivation of SSB transmissions of an NES node/cell associated with the anchor node. In some examples, by dynamically activating/deactivating the SSB transmissions of an NES node/cell associated with the anchor node, the described techniques can be used to reduce network energy expenditures in scenarios for which UEs are idle or not present in the coverage area of the NES node/cell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

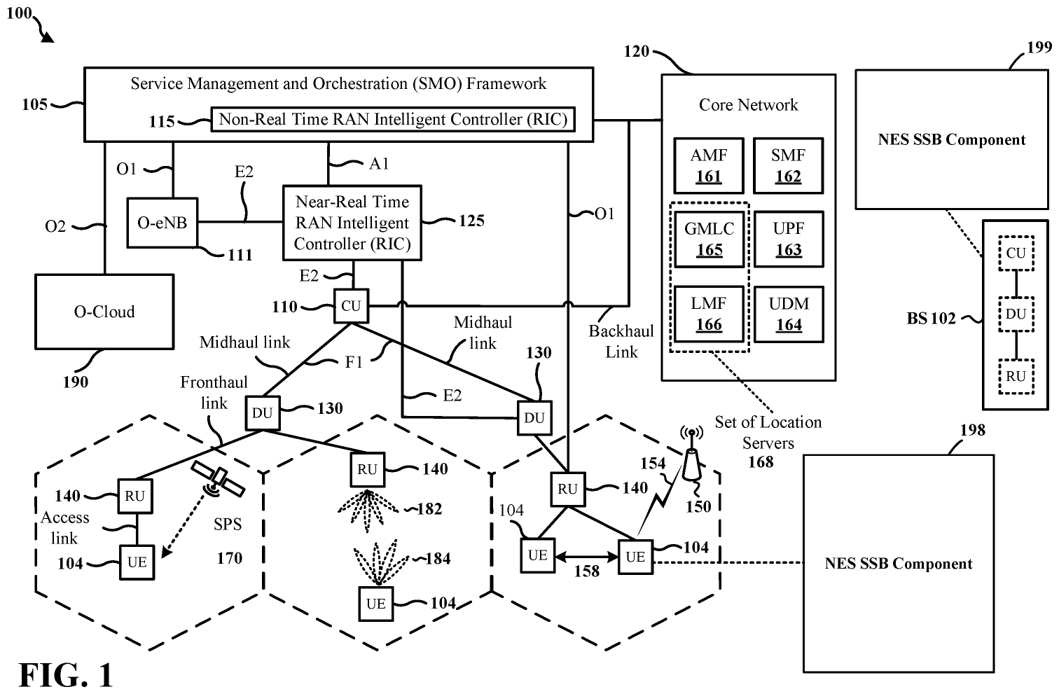

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an NES SSB component 198 (“component 198”) that may be configured to obtain location information associated with the UE. The component 198 may also be configured to detect, based on the location information associated with the UE, that a condition is met, where the condition is associated with a parameter-based relationship of the UE to a first network node. The component 198 may also be configured to transmit, based on the condition being met, an indication associated with an activation or a deactivation of a set of SSB transmissions at one or more of the first network node or a second network node. The component 198 may also be configured to receive, from the first network node and based on the indication being indicative of the activation, the set of SSB transmissions, where the set of SSB transmissions comprises at least one of a system information block type 1 (SIB1), a physical random access channel (PRACH), or a remaining minimum SIB1 (RMSI).

In certain aspects, the base station 102 may have an NES SSB component 199 (“component 199”) that may be configured to select a sleep state configuration, where the sleep state configuration is associated with at least one of a power or a latency for a sleep state for a second network node. The component 199 may also be configured to transmit, to the second network node and based on the sleep state configuration, an indication associated with an activation or a deactivation of a set of SSB transmissions at the second network node, where the indication is indicative of sleep state information associated with the sleep state and the deactivation. The component 199 may also be configured to receive, from the second network node, a capability indication that is indicative of support of the second network node for at least one of a set of sleep state types, a set of respective expected durations of the set of sleep state types, or a set of respective minimum durations of the set of sleep state types, where selecting the sleep state configuration is based on at least one of the set of sleep state types.

Accordingly, aspects herein for on-demand SSB transmissions for NES cells based on location information enable the dynamic activation/deactivation of SSB transmissions of an NES node/cell associated with an anchor node by obtaining location information associated with a UE, e.g., from the UE or the anchor node, and enable reduced network energy expenditures in scenarios for which UEs are idle or not present in the coverage area of the NES node/cell by dynamically activating/deactivating the SSB transmissions of the NES node/cell associated with the anchor node.

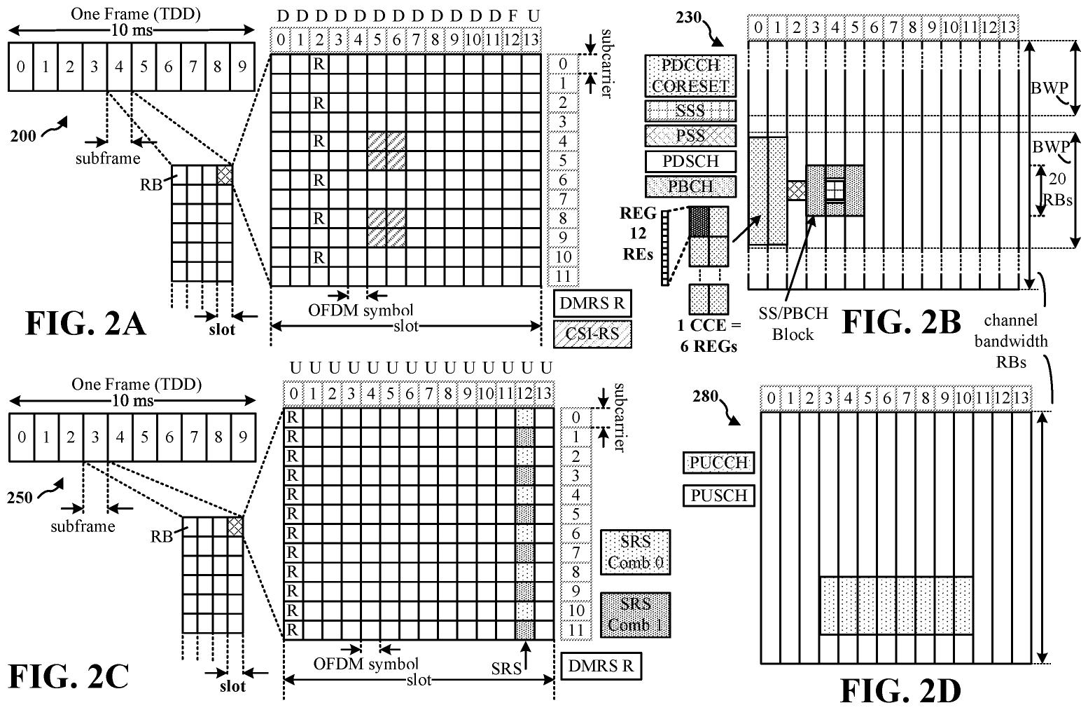

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

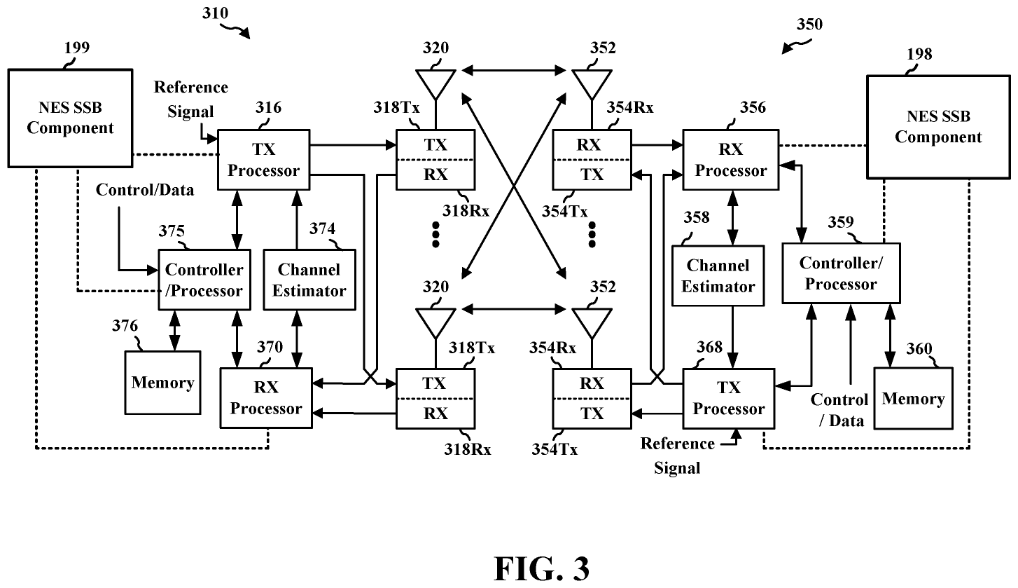

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A network node and a UE in a wireless communication network may communicate in various configurations and using various communication schema to conserve power and energy in the network. One example communication scheme to conserve network energy utilizes an NES cell(s) for on-demand SSB transmission for SCell for connected UEs. In such solutions, triggering methods for on-demand SSB transmission may be utilized (e.g., a UE UL wake-up signal using an existing signal/channel, cell on/off indications via backhaul, SCell activation/deactivation signaling, etc.). However, as NES cells are within the coverage area of an anchor cell and may be added as SCells for connected UEs, energy savings issues may arise due to the lack of support for idle UEs. That is, when idle UEs, or no UEs, are within the range of an NES cell, the NES cell may continue to provide SSB transmissions and expend network power/energy. Further to this issue, without SSB transmissions from an NES cell, there is no measurement between the NES and a UE to discover whether the UE is within cell coverage of the NES cell.

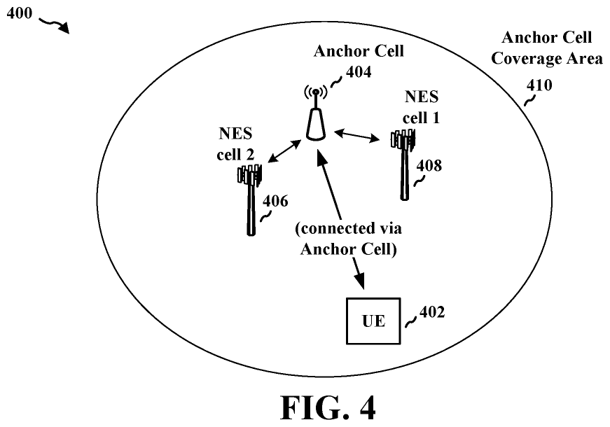

FIG. 4 is a diagram 400 illustrating an example of a configuration for an anchor cell with NES cells. Diagram 400 is shown in the context of a UE 402 and an anchor cell 404 (e.g., a base station, gNB, etc.), as well as NES cells: an NES cell 406 and an NES cell 408, which are within a coverage area 410 of the anchor cell 404.

As illustrated, the UE 402 may be a connected UE that is connected via the anchor cell 404. The NES cell 406 and the NES cell 408 may be configured to provide SSB transmissions to the UE 402, e.g., such NES cells may be added as an SCell(s) for connected UEs by network configuration, such as shown for the UE 402. However, the NES cell 406 and the NES cell 408 may not support idle UEs and may not be aware of scenarios in which the UE 402 enters/leaves the coverage area 410. In order to save energy at a given NES cell, SSB transmissions may be turned off if no UEs are around the NES cell's coverage are, and turned on SSB if at least one UE is around the NES cell's coverage area. Yet, without SSB transmissions from the NES cell 406 or the NES cell 408, there is no measurement between these cells and the UE 402 to discover whether the UE 402 is within cell coverage of the NES cell 406 and/or the NES cell 408.

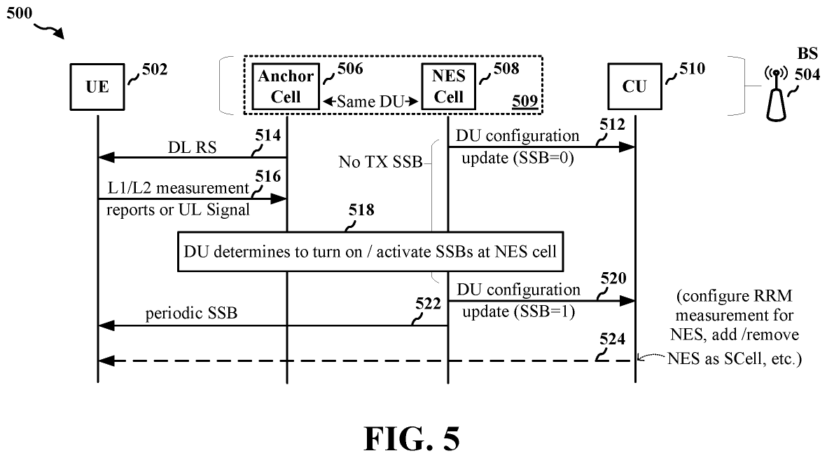

FIG. 5 is a diagram 500 illustrating an example of an SSB configuration for a NES cell of an anchor cell. Diagram 500 is shown in the context of a UE 502, an anchor cell 506, an NES cell 508, and a CU 510. In aspects, the anchor cell 506 and the NES cell 508 may comprise a DU 509 (e.g., the same DU), and the DU 509 and the CU 510 may comprise a base station 504 (e.g., a gNB and/or the like).

In the illustrated example, the DU 509 may turn on/off the SSB transmissions (e.g., a periodic SSB 522) of the NES cell 508 based on a rough/estimated location of the UE 502 obtained via L1/L2 measurement reports of the UE 502 (e.g., information/signaling 516 based on a DL RS 514) via the anchor cell 506 or via UL measurements performed by the anchor cell 506 (e.g., based on the information/signaling 516). The DU 509 may notify the CU 510 of activation/deactivation of the SSB transmissions (e.g., the periodic SSB 522) for the NES cell 508. In the existing F1 application protocol (F1-AP) interface, the DU 509 can notify the CU 510 of its SSB status using servedCellInfo::(SSBPositioninBurst and measurementTimingConfig) via a gNB-DU configuration update message. In one example, for deactivation of the SSB transmissions, the DU 509 may provide to the CU 510, a DU configuration update 520 with SSBPositioninBurst=0 and measurementTimingConfig (empty).

In some examples, from a beam management report, a rough/estimated direction of the UE 502 (e.g., via an SSB/CSI-RS beam index, or PMI) and distance (e.g., via an RSRP measurement) from the anchor cell 506 can be estimated. In some examples, from an UL transmission(s) (e.g., PRACH, SRS), the anchor cell 506 can estimate the direction of the UE 502 (e.g., via a Quasi Co-Location (QCL) SSB) and a distance from an RSRP measurement(s) or a round-trip delay(s). If the anchor cell 506 and the NES cell 508 are within the same DU, e.g., the DU 509, the DU 509 may also have history data to show a correlation(s) of the location information of the UE 502 with the NES cell 508 coverage area, and may be able to make a decision(s) on whether to turn on the NES cell 508 SSB transmissions (e.g., the periodic SSB 522). In such cases, the DU 509 may determine to turn on/activate (at 518) the periodic SSB 522 at the NES cell 508. In one example, the DU 509 may provide to the CU 510, a DU configuration update 512 with SSBPositioninBurst=0. In another example, for activation of the SSB transmissions, the DU 509 may provide to the CU 510, a DU configuration update 520 with SSBPositioninBurst=1 and measurementTimingConfig (non-empty). The CU 510 may subsequently provide a configuration(s) 524 to the UE 502 for radio resource management (RRM) measurements for the NES cell 508, to add/remove the NES cell 508 as an SCell, etc.

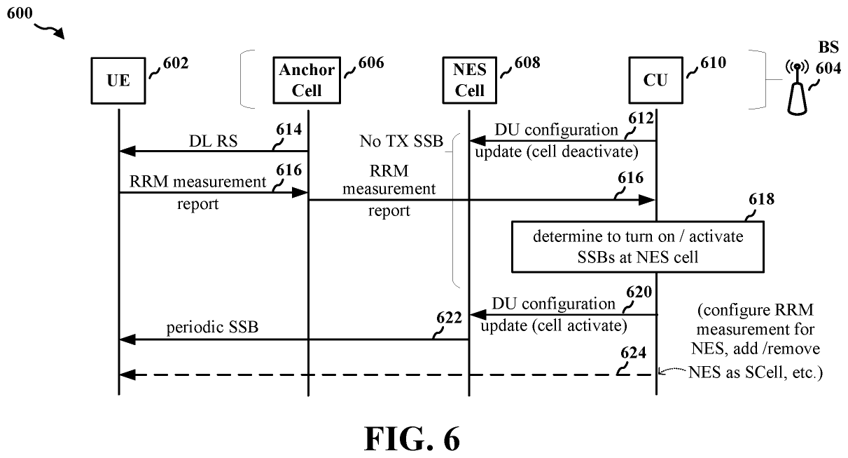

FIG. 6 is a diagram 600 illustrating an example of an SSB configuration for a NES cell of an anchor cell. Diagram 600 is shown in the context of a UE 602, an anchor cell 606, an NES cell 608, and a CU 610. In aspects, the anchor cell 606 and the NES cell 608 may comprise a DU (e.g., the same DU) or may be portions of separate DUs. In aspects, the DU(s) and the CU 510 may comprise a base station 604 (e.g., a gNB and/or the like).

In the illustrated example, the CU 610 may request to turn on/off SSB transmissions (e.g., periodic SSB 622) of the NES cell 608 based on the location of the UE 602 that is obtained from an RRM measurement report 616 from the UE 602 (e.g., from a measurement(s) of a DL RS 614). In one example, a rough/estimated location of the UE 602 may be obtained by the CU 610 via the anchor cell 606 from a beam level report included in the RRM measurement report 616 (e.g., an SSB or CSI-RS resource index, RSRP). In some examples, location information obtained from a GNSS by the UE 602 side may also be included inside the RRM measurement report 616 when configured.

In the existing F1-AP interface, the CU 610 may send a gNB-CU configuration update message to a DU to request the cell activation/deactivation (e.g., a DU configuration update 612 (for deactivation), a DU configuration update 620 (for activation)). In some examples, the cell activation may be enhanced to include activation of a list of SSBs. If a list of SSBs is not included, the cell activation may turn on all SSBs, and the cell deactivation may turn off all SSBs. In the illustrated example, based on at least on the RRM measurement report 616, the CU 610 may determine to turn on/activate (at 618) the periodic SSB 622 at the NES cell 608. The CU 610 may subsequently provide a configuration(s) 624 to the UE 602 for RRM measurements for the NES cell 608, to add/remove the NES cell 608 as an SCell, etc.

The description above for FIGS. 4-6 illustrate configurations for which power consumption/energy expenditures in communication networks may be improved. For instance, NES cells may lack the ability to support idle UEs and determine when UEs enter/leave the coverage area of a NES cell (FIG. 4). With respect to FIG. 5, a DU may obtain rough/coarse location information (e.g., an estimate) based on beam management via an anchor cell. In a typical deployment of an anchor cell with FR1 (e.g., low carrier frequency with a larger coverage) and an NES cell with FR2 (e.g., relative high carrier frequency with a smaller coverage), there are few broad beams (e.g., max=8) at FR1 for the anchor cell, which is coarse. Further, while a UE's GNSS location can be sent to a CU via an RRM measurement report, it may not be useful (e.g., increase power/energy expenditure for Rx/Tx) to continue reporting GNSS location if the UE's location is far from the NES cell's coverage area. With respect to FIG. 6, a CU may request a DU to deactivate an NES cell, and when the cell is deactivated, it may have different sleep states (e.g., micro sleep, light sleep, deep sleep, as defined for gNB power models), which may have different levels of power consumption and transition times. For example, in a deeper sleep, an NES cell consumes less power but utilizes a longer transition time.

Aspects herein for on-demand SSB transmissions for NES cells based on location information provide improvements to enable a UE to send a request once it enters around a NES cell's coverage area, and thus, signaling overhead can be saved at the UE and at the network. An NES cell may be a network cell or node utilized to provide additional cell coverage for UEs, such as a portion of a base station, gNB, DU, etc., by which dynamic activation/deactivation of SSB transmissions for the UEs may be configured based on UE location information and/or a parameter-based relationship of a given UE to the NES cell. An NES cell may be a network cell or node by which dynamic activation/deactivation of SSB transmissions for UEs may be configured based on UE location information and/or a parameter-based relationship of the UE to the NES cell. For instance, aspects herein provide for configurations to turn on/off a NES cell's SSB transmissions based on a UE's location information via an anchor cell. That is, configurations for UE communications with an anchor cell enable use of the UE's location information, e.g., as obtained by the anchor cell, to trigger on-demand SSB transmission activation/deactivation at NES cells. Aspects herein also enable a CU to explicitly or implicitly indicate a sleep state for a deactivated NES cell to tradeoff between power consumption and latency for activation of the NES cell, e.g., to add the NES cell as an SCell.

In some deployment scenarios, such as for the case where an anchor cell and an NES cell are in different frequency ranges, it may not be as straightforward and simple as the other cases for the anchor cell to determine whether to turn the NES cell on and/or off. Further, when considering multiple, different implementation specific sleep states of NES cells, it may be beneficial for a CU to take into consideration the sleep state of the NES cell in deciding whether to turn on/off the NES cell as the transition time from the off state to the on state can be different. aspects herein provide for two schemes associated with the above. In one example, a UE requests an anchor cell to turn on/off an NES cell's SSB transmissions based on a set of information, and such a request may be made by sending an uplink (UL) wake-up signal (UL-WUS) to the NES cell from the UE. In another example, for identifying/determining whether to activate an NES cell, a CU may take a DU sleep state(s) and/or state transition time(s) into consideration. Aspects described herein for on-demand SSB transmissions for NES cells based on location information provide solutions to such issues. As one example, aspects enable the dynamic activation/deactivation of SSB transmissions of an NES node/cell associated with an anchor node by obtaining location information associated with a UE, e.g., from the UE or the anchor node. As another example, aspects enable reduced network energy expenditures in scenarios for which UEs are idle or not present in the coverage area of the NES node/cell by dynamically activating/deactivating the SSB transmissions of the NES node/cell associated with the anchor node. As used herein, the terms NES node and NES cell may be used interchangeably unless otherwise specified.

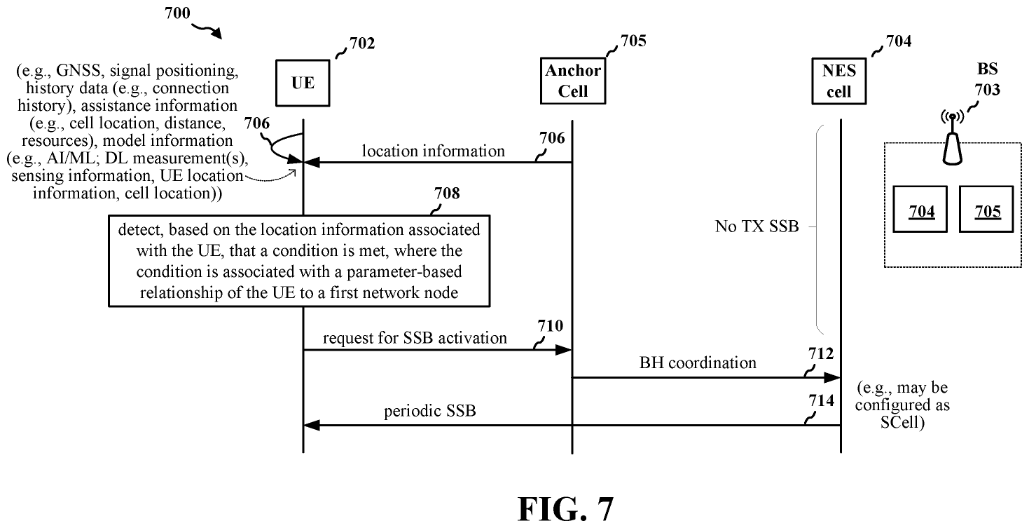

FIG. 7 is a call flow diagram 700 for wireless communications, in various aspects. Call flow diagram 700 illustrates on-demand SSB transmissions for NES cells based on location information for a wireless device (a UE 702, by way of example) that communicates with a first network node (e.g., an NES cell 704) and a second network node (e.g., an anchor cell 705) which may comprise one or more network nodes/entities (e.g., a base station 703, such as a gNB or other type of base station or a DU(s), by way of example, as shown and described herein), in various aspects. Aspects described for the base station 703, and for network nodes herein, generally, may be performed in aggregated form and/or by one or more components in disaggregated form. Additionally, or alternatively, the aspects may be performed by the UE 702 autonomously, in addition to, and/or in lieu of, operations of the base station 703, the NES cell 704, and/or the anchor cell 705.

In the illustrated aspect, the UE 702 may be configured to obtain location information 706 associated with the UE 702. The UE may be configured to receive, and the anchor cell 705 may be configured to transmit/provide, the location information 706. The location information 706 may include one or more parameters by which condition for a parameter-based relationship between the UE 702 and the NES cell 704 may be detected/identified.

In aspects, the location information 706 may include history data associated with the UE 702, assistance information associated with the anchor cell 705 of the UE 702, and/or model information associated with an output of at least one of an artificial intelligence (AI) algorithm or a machine learning (ML) model and one or more respective inputs (e.g., at the UE 702). In some aspects, the location information may be based on a GNSS, a signaling positioning service of a radio network associated with the UE 702, and/or the like. In aspects, the history data may be based on a connection history between the UE 702 and the NES cell 704 (e.g., the first network node) that may show a correlation of the location of the UE 702 with coverage of the NES cell 704. In some aspects, the assistance information may be based on a cell location of the NES cell 704, a distance associated with the condition (e.g., a distance between the UE 702 and the NES cell 704 meeting a threshold condition to trigger a request for SSB activation, such as the distance being less than, or less than or equal to a threshold distance), one or more resources associated with the indication of the location information 706, and/or the like. In some aspects, the one or more respective inputs associated with the AI algorithm/the ML model may include a downlink measurement of a signal associated with the anchor cell 705, sensing information associated with the UE 702 (e.g., a camera picture of the environment for the UE 702), the location information 706, the cell location (e.g., of the NES cell 704), and/or the like.

The UE 702 may be configured to detect (at 708), based on the location information 706 associated with the UE 702, that a condition is met. As noted, the condition may be associated with a parameter-based relationship of the UE 702 to the NES cell 704 (e.g., the first network node), and may be based on one or more of the parameters described above. In aspects, the detection (at 708) may indicate that the UE 702 is within the coverage area of the NES cell 704.

The UE 702 may be configured to transmit/provide, based on the condition being met, an indication (e.g., a request 710 for SSB activation) associated with an activation or a deactivation of a set of SSB transmissions at one or more of the NES cell 704 (e.g., the first network node) or the anchor cell 705 (e.g., the second network node, an anchor cell, etc.). In the illustrated aspect, the UE 702 may be configured to transmit/provide, and the anchor cell 705 may be configured to receive, the request 710 for SSB activation. The request 710 for SSB activation may be associated with SSB activation at the NES cell 704. Accordingly, the anchor cell 705 may provide backhaul (BH) coordination signaling 712 to the NES cell 704 to forward the request to activate the set of SSB transmissions, as described herein for anchor cells and NES cells that in a same DU or in different DUs (e.g., where the anchor DU may forward requests via a CU that communicates via an F1-AP interface with the NES cell DU). Subsequent to the BH coordination signaling 712, the NES cell 704 may be configured as an SCell of the UE 702.

The UE 702 may be configured to receive, and the NES cell 704 may be configured to transmit/provide, the set of SSB transmissions (e.g., periodic SSB transmissions 714) based on an activation thereof, as described above. In aspects, the UE 702 may be configured to receive, from the NES cell 704 and based on the indication (e.g., the request 710) being indicative of the activation, the set of SSB transmissions (e.g., the periodic SSB transmissions 714). The periodic SSB transmissions 714 may be the set of SSB transmissions and may comprise at least one of a system information block type 1 (SIB1), a PRACH, or a remaining minimum SIB1 (RMSI). Aspects herein also provide for a request for SSB deactivation in place of the request 710 for SSB activation, which may result in the deactivation of the periodic SSB transmissions 714. Such deactivation may be similarly based on the location information 706 and the condition associated with the parameter-based relationship of the UE 702 and the NES cell 704.

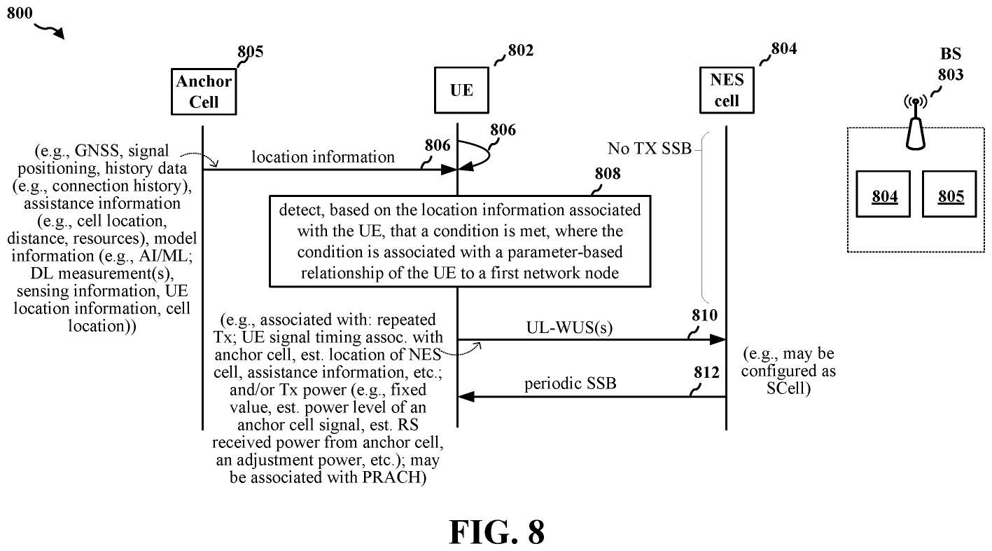

FIG. 8 is a call flow diagram 800 for wireless communications, in various aspects. Call flow diagram 800 illustrates on-demand SSB transmissions for NES cells based on location information for a wireless device (a UE 802, by way of example) that communicates with a first network node (e.g., an NES cell 804) and a second network node (e.g., an anchor cell 805) which may comprise one or more network nodes/entities (e.g., a base station 803, such as a gNB or other type of base station or a DU(s), by way of example, as shown and described herein), in various aspects. Aspects described for the base station 803, and for network nodes herein, generally, may be performed in aggregated form and/or by one or more components in disaggregated form. Additionally, or alternatively, the aspects may be performed by the UE 802 autonomously, in addition to, and/or in lieu of, operations of the base station 803, the NES cell 804, and/or the anchor cell 805.

In the illustrated aspect, the UE 802 may be configured to obtain location information 806 associated with the UE 802. The UE may be configured to receive, and the anchor cell 805 may be configured to transmit/provide, the location information 806. The location information 806 may include one or more parameters by which condition for a parameter-based relationship between the UE 802 and the NES cell 804 may be detected/identified.

In aspects, the location information 806 may include history data associated with the UE 802, assistance information associated with the anchor cell 805 of the UE 802, and/or model information associated with an output of at least one of an artificial intelligence (AI) algorithm or a machine learning (ML) model and one or more respective inputs (e.g., at the UE 802). In some aspects, the location information may be based on a GNSS, a signaling positioning service of a radio network associated with the UE 802, and/or the like. In aspects, the history data may be based on a connection history between the UE 802 and the NES cell 804 (e.g., the first network node) that may show a correlation of the location of the UE 802 with coverage of the NES cell 804. In some aspects, the assistance information may be based on a cell location of the NES cell 804, a distance associated with the condition (e.g., a distance between the UE 802 and the NES cell 804 meeting a threshold condition to trigger a request for SSB activation, such as the distance being less than, or less than or equal to a threshold distance), one or more resources associated with the indication of the location information 806, and/or the like. In some aspects, the one or more respective inputs associated with the AI algorithm/the ML model may include a downlink measurement of a signal associated with the anchor cell 805, sensing information associated with the UE 802 (e.g., a camera picture of the environment for the UE 802), the location information 806, the cell location (e.g., of the NES cell 804), and/or the like.

The UE 802 may be configured to detect (at 808), based on the location information 806 associated with the UE 802, that a condition is met. As noted, the condition may be associated with a parameter-based relationship of the UE 802 to the NES cell 804 (e.g., the first network node), and may be based on one or more of the parameters described above. In aspects, the detection (at 808) may indicate that the UE 802 is within the coverage area of the NES cell 804.

The UE 802 may be configured to transmit/provide, based on the condition being met, an indication (e.g., an UL-WUS 810 for SSB activation) associated with an activation or a deactivation of a set of SSB transmissions at the NES cell 804 (e.g., the first network node). In the illustrated aspect, the UE 802 may be configured to transmit/provide, and the NES cell 804 may be configured to receive, the UL-WUS 810. The UL-WUS 810 may be associated with SSB activation. Accordingly, the UL-WUS 810 may cause the NES cell 804 to activate the set of SSB transmissions, as described.

There may be impact to the UE 802 power consumption in FR2, as the UE 802 may repeat TX in the set of SSB transmissions as periodic SSB transmissions 812 for UL beam management, due to an absence of SSBs before transmission of the UL-WUS 810. As there are no SSB transmissions from the NES cell 804 prior to activation, TX timing of the UL-WUS 810 may be based on the UE 802 RX or TX timing for the anchor cell 805. The NES cell 804 may place a search window for reception of the UL-WUS 810. In some aspects, the UE 802 may adjust its TX timing based on its estimated (e.g., rough) location and additional assistance information provided by the network (e.g., via the anchor cell 805, a CU, etc.). TX power of the UL-WUS 810 may be based on any (combination of) a fixed value, an estimated PL/RSRP from the anchor cell 805, additional adjustment indicated by the anchor cell 805 or selected by the UE 802 (e.g., based on its estimated location and/or the extra assistance information). In aspects, the NES cell 804 may turn on SSB transmissions (e.g., the periodic SSB transmissions 812 (the set of SSB transmissions)) if the UL-WUS 810 can be detected, but otherwise may not turn on SSB transmissions. The illustrated aspect in call flow diagram 800 takes into account RF conditions via the UL measurement for turning on the periodic SSB transmissions 812, which may be different than aspects described above for call flow diagram 700 in FIG. 7 which may be based on location information to turn on SSB transmissions. In some aspects, after turning on/activating the periodic SSB transmissions 812 (the set of SSB transmissions) and configuring a measurement report call flow diagram 700 in FIG. 7, it may be realized that the NES cell may not be a suitable cell as/for an SCell due to poor RF conditions, which has a larger latency and network power consumption than the aspect illustrated in call flow diagram 800.

In aspects, the UL-WUS 810 may be associated with at least one of: at least one repeated transmission of the UL-WUS 810, a UE 802 signal timing associated with at least one of the anchor cell 805 (e.g., the second network node), an estimated location of the NES cell 804 (e.g., the network energy savings node), or assistance information of a radio network associated with the UE 802. In aspects, the UL-WUS 810 may be associated with a transmit power based on at least one of a fixed value, an estimated power level of a signal associated with the anchor cell 805 (e.g., the second network node), an estimated reference signal received power associated with the anchor cell 805 (e.g., the second network node), or an adjustment power associated with at least one of the UE 802 or the anchor cell 805 (e.g., the second network node). In aspects, the UL-WUS 810 may be associated with a PRACH. Subsequent to the UL-WUS 810, the NES cell 804 may be configured as an SCell of the UE 802.

The UE 802 may be configured to receive, and the NES cell 804 may be configured to transmit/provide, the set of SSB transmissions (e.g., the periodic SSB transmissions 812) based on an activation thereof, as described above. In aspects, the UE 802 may be configured to receive, from the NES cell 804 and based on the indication (e.g., the UL-WUS 810) being indicative of the activation, the set of SSB transmissions (e.g., the periodic SSB transmissions 812). The periodic SSB transmissions 812 may comprise at least one of a SIB1, a PRACH, or an RMSI. Aspects herein also provide for SSB deactivation via the UL-WUS 810 in place of the UL-WUS 810 for SSB activation, which may result in the deactivation of the periodic SSB transmissions 812. Such deactivation may be similarly based on the location information 806 and the condition associated with the parameter-based relationship of the UE 802 and the NES cell 804.

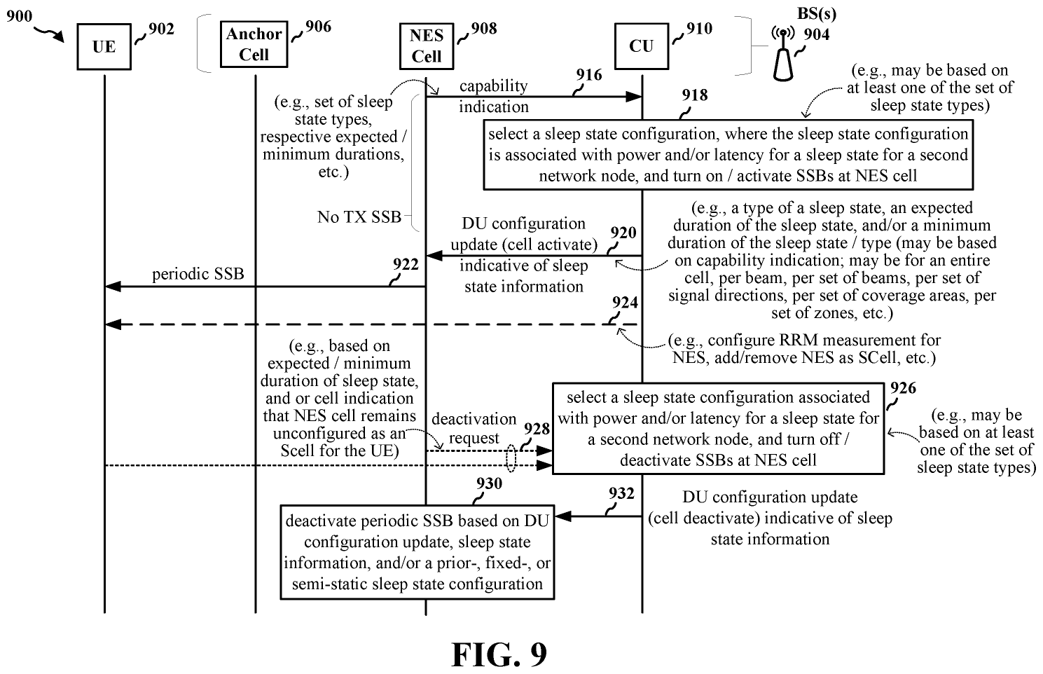

FIG. 9 is a call flow diagram 900 for wireless communications, in various aspects. Call flow diagram 900 illustrates on-demand SSB transmissions for NES cells based on location information for a wireless device (a UE 902, by way of example) that communicates with a first network node (e.g., a CU 910) and a second network node (e.g., an NES cell 908) which may comprise one or more network nodes/entities (e.g., a base station(s) 904, such as a gNB or other type of base station or a CU(s)/DU(s) (which may include an anchor cell 906), by way of example, as shown and described herein), in various aspects. Aspects described for the base station(s) 904, and for network nodes herein, generally, may be performed in aggregated form and/or by one or more components in disaggregated form. Additionally, or alternatively, the aspects may be performed by the UE 902 autonomously, in addition to, and/or in lieu of, operations of the base station(s) 904, the NES cell 908, and/or the anchor cell 906.

In the illustrated example, the CU 910 may be configured to receive, and the NES cell 908 may be configured to transmit/provide, a capability indication 916. The capability indication 916 may be indicative of support of the NES cell 908 (e.g., the second network node) for at least one of a set of sleep state types, a set of respective expected durations of the set of sleep state types, or a set of respective minimum durations of the set of sleep state types. In aspects, the CU 910 may be configured to transmit/provide, and the NES cell 908 may be configured to receive (e.g., as a second network node), an indication (e.g., a DU configuration update 920, a DU configuration update 932) that is associated with an activation or a deactivation of a set of SSB transmissions at the NES cell 908, and such an indication(s) may be associated with and/or based on the capability indication 916.

The CU 910 may be configured to request to turn on/off SSB transmissions (e.g., a periodic SSB) of the NES cell 908 based on the location of the UE 902 that is obtained from an RRM measurement report from the UE 902 (e.g., from a measurement(s) of a DL RS). In one example, a rough/estimated location of the UE 902 may be obtained by the CU 910 via the anchor cell 906 from a beam level report included in the RRM measurement report (e.g., an SSB or CSI-RS resource index, RSRP). In some examples, location information obtained from a GNSS by the UE 902 side may also be included inside the RRM measurement report when configured.

In the existing F1-AP interface, the CU 910 may send a gNB-CU configuration update message, as an indication associated with an activation or a deactivation of a set of SSB transmissions (e.g., the periodic SSB transmissions 922), to a DU to request the cell activation/deactivation (e.g., the DU configuration update 920 (for activation), the DU configuration update 932 (for deactivation)). In some examples, the cell activation may be enhanced to include activation of a list of SSBs. If a list of SSBs is not included, the cell activation may turn on all SSBs, and the cell deactivation may turn off all SSBs. In the illustrated example, based on at least on the RRM measurement report, the CU 910 may be configured to select a sleep state configuration and to turn on/activate (at 918) the periodic SSB transmissions 922 (e.g., a set of SSB transmissions) at the NES cell 908. The sleep state configuration may be based on/associated with at least one of a power or a latency for a sleep state for a second network node (e.g., the NES cell 908). In aspects, to turn off/deactivate the periodic SSB transmissions 922 (e.g., a set of SSB transmissions) at the NES cell 908, the CU 910 may be configured to receive, from the second network node (e.g., the NES cell 908), a deactivation request 928 (described below) associated with the activation (e.g., via the DU configuration update 920) of the set of SSB transmissions (e.g., the periodic SSB transmissions 922), where the deactivation request 928 may be based on at least one of the expected duration of the sleep state, the minimum duration of the sleep state, or a cell indication indicative of NES cell 908 (e.g., the second network node) remaining unconfigured as a secondary cell (SCell) of the UE 902. In some aspects, the CU 910 may be configured to receive, from the UE 902, the deactivation request 928 in addition to, or in lieu of, reception from the NES cell 908. As described, the CU 910 may be configured to transmit/provide, and the NES cell 908 may be configured to receive (e.g., as a second network node), an indication associated with an activation or a deactivation of a set of SSB transmissions, such as the DU configuration update 920, e.g., for cell activation. The indication/DU configuration update 920 may be indicative of sleep state information. In aspects, the sleep state information may include, without limitation, at least one of a type of a sleep state, an expected duration of the sleep state, a minimum duration of the sleep state, and/or the like. In aspects, a portion of the sleep state information indicated by the indication/DU configuration update may be implicitly indicated based on at least one of a prior sleep state configuration, a fixed sleep state configuration, or a semi-static sleep state configuration. In some aspects, the indication/DU configuration update 920 may be associated with at least one of: an entire cell of the NES cell 908 (e.g., the second network node), a per beam configuration, a set of beams, a set of signal directions, a set of coverage areas, a set of zones, and/or the like. Upon cell activation, the NES cell 908 may configured to provide the periodic SSB transmissions 922 (e.g., the set of SSB transmissions) to the UE 902, and the CU 910 may be configured to subsequently provide a configuration(s) 924 to the UE 902 for RRM measurements for the NES cell 908, to add/remove the NES cell 908 as an SCell, etc.

As described, the CU 910 may be configured to turn off/deactivate of a set of SSB transmissions (e.g., the periodic SSB transmissions 922) at the NES cell 908. For example, the CU 910 may be configured to select (at 926) a sleep state configuration associated with at least one of a power or a latency for a sleep state for the NES cell 908 (e.g., a second network node), and to turn off/deactivate the periodic SSB transmissions 922 (the set of SSB transmissions) at the NES cell 908. In aspects, the selection/deactivation (at 926) may be based on the deactivation request 928, described above, and/or on be based on at least one of the expected duration of the sleep state, the minimum duration of the sleep state, or a cell indication indicative of NES cell 908 (e.g., the second network node) remaining unconfigured as an SCell of the UE 902 as otherwise determined by the CU 910.

The deactivation determination for the selection/deactivation (at 926) may be followed by the CU 910 transmitting/providing the DU configuration update 932 (e.g., as an indication, based on the sleep state configuration, for deactivation) to the NES cell 908. The NES cell 908 may be configured to deactivate (at 930) the periodic SSB transmission 922 (e.g., the set of SSB transmissions). In aspects, such a deactivation (at 930) may be based on the DU configuration update 932 (for deactivation), the sleep state information, and/or at least one of a prior sleep state configuration, a fixed sleep state configuration, or a semi-static sleep state configuration (e.g., which may be for the minimum duration). The DU may turn off the periodic SSB transmissions 922 (the set of SSB transmissions) or deactivate the NES cell 908 (or send the deactivation request 928 to the CU 910) after expiry of the associated duration. This may be further dependent on additional criteria, such as but not limited to: deactivation may be allowed if by the end of expiry time, the NES cell 908 has not been added/configured as an SCell for a UE 902. In one example, the CU 910 may be configured to explicitly indicate for (at least) how long the DU should keep the NES cell 908 actively transmitting the periodic SSB transmissions 922 (the set of SSB transmissions). In some aspects, the DU may determine the sleep state during the deactivated state of the NES cell 908 based on an implementation thereof.

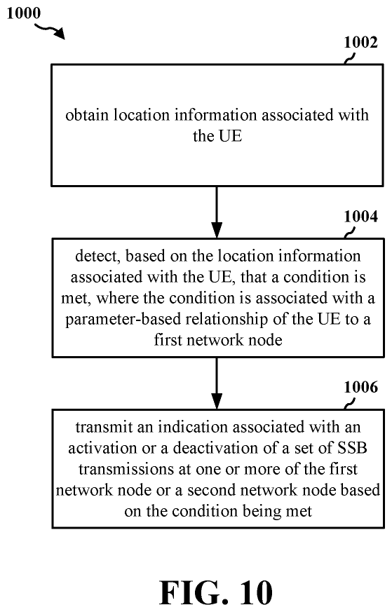

FIG. 10 is a flowchart 1000 of a method of wireless communication. The method may be performed by a UE (e.g., the UE 104, 702, 802, 902; the apparatus 1404). In some aspects, the method may include aspects described in connection with the communication flows in FIGS. 7, 8, 9, and/or aspects described in FIGS. 4-6. The method may be for on-demand SSB transmissions for NES cells based on location information. The method may enable the dynamic activation/deactivation of SSB transmissions of an NES node/cell associated with an anchor node by obtaining location information associated with a UE, e.g., from the UE or the anchor node, and enable reduced network energy expenditures in scenarios for which UEs are idle or not present in the coverage area of the NES node/cell by dynamically activating/deactivating the SSB transmissions of the NES node/cell associated with the anchor node.

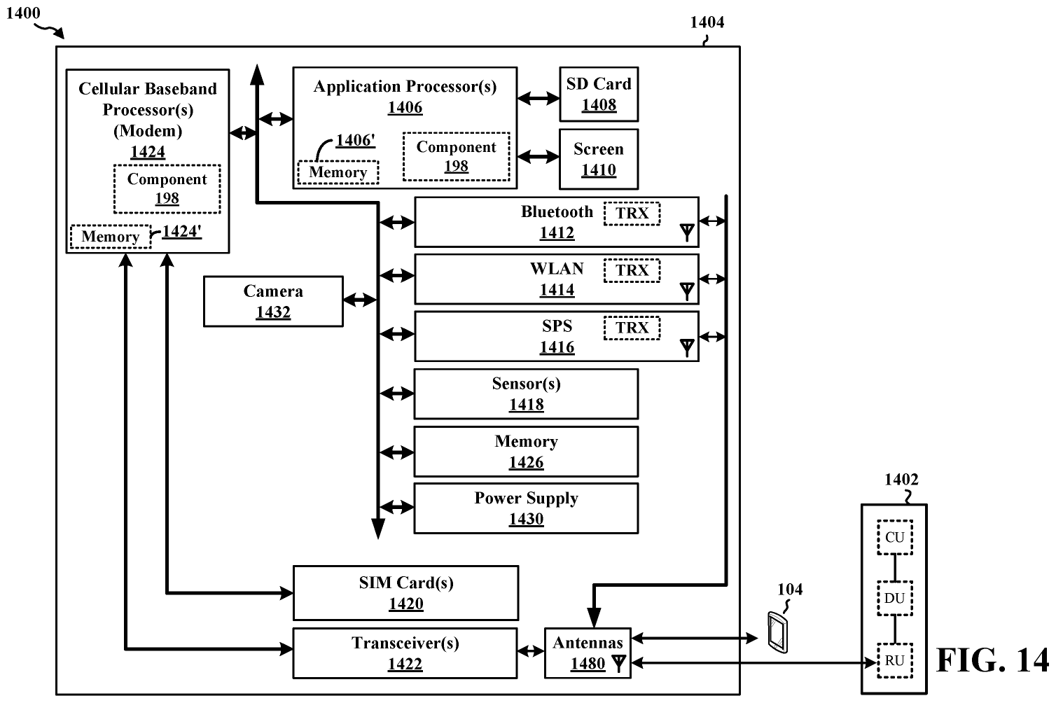

At 1002, the UE obtains location information associated with the UE. As an example, the obtainment may be performed by one or more of the component 198, the transceiver(s) 1422, and/or the antenna 1480 in FIG. 14. FIG. 7 illustrates, in the context of FIG. 8, an example of the UE 702 obtaining such location information.

The UE 702 may be configured to obtain location information 706 associated with the UE 702. The UE may be configured to receive, and the anchor cell 705 may be configured to transmit/provide, the location information 706. The location information 706 may include one or more parameters by which condition for a parameter-based relationship between the UE 702 and the NES cell 704 may be detected/identified.

In aspects, the location information 706 may include history data associated with the UE 702, assistance information associated with the anchor cell 705 of the UE 702, and/or model information associated with an output of at least one of an artificial intelligence (AI) algorithm or a machine learning (ML) model and one or more respective inputs (e.g., at the UE 702). In some aspects, the location information may be based on a GNSS, a signaling positioning service of a radio network associated with the UE 702, and/or the like. In aspects, the history data may be based on a connection history between the UE 702 and the NES cell 704 (e.g., the first network node) that may show a correlation of the location of the UE 702 with coverage of the NES cell 704. In some aspects, the assistance information may be based on a cell location of the NES cell 704, a distance associated with the condition (e.g., a distance between the UE 702 and the NES cell 704 meeting a threshold condition to trigger a request for SSB activation, such as the distance being less than, or less than or equal to a threshold distance), one or more resources associated with the indication of the location information 706, and/or the like. In some aspects, the one or more respective inputs associated with the AI algorithm/the ML model may include a downlink measurement of a signal associated with the anchor cell 705, sensing information associated with the UE 702 (e.g., a camera picture of the environment for the UE 702), the location information 706, the cell location (e.g., of the NES cell 704), and/or the like.

At 1004, the UE detects, based on the location information associated with the UE, that a condition is met, where the condition is associated with a parameter-based relationship of the UE to a first network node. As an example, the detection may be performed by one or more of the component 198, the transceiver(s) 1422, and/or the antenna 1480 in FIG. 14. FIG. 7 illustrates, in the context of FIG. 8, an example of the UE 702 detecting such a condition associated with a parameter-based relationship of the UE 702 to a first network node (e.g., the NES cell 704).

The UE 702 may be configured to detect (at 708), based on the location information 706 associated with the UE 702, that a condition is met. As noted, the condition may be associated with a parameter-based relationship of the UE 702 to the NES cell 704 (e.g., the first network node), and may be based on one or more of the parameters described above. In aspects, the detection (at 708) may indicate that the UE 702 is within the coverage area of the NES cell 704.

At 1006, the UE transmits an indication associated with an activation or a deactivation of a set of SSB transmissions at one or more of the first network node or a second network node based on the condition being met. As an example, the transmission may be performed by one or more of the component 198, the transceiver(s) 1422, and/or the antenna 1480 in FIG. 14. FIGS. 7, 8 illustrate an example of the UE 702/the UE 802 transmitting/providing such an indication to the NES cell 704/804 and/or the anchor cell 705/805 and/or the base station 703/803.

In the context of FIG. 7, the UE 702 may be configured to transmit/provide, based on the condition being met, an indication (e.g., a request 710 for SSB activation) associated with an activation or a deactivation of a set of SSB transmissions at one or more of the NES cell 704 (e.g., the first network node) or the anchor cell 705 (e.g., the second network node, an anchor node, etc.). In the illustrated aspect, the UE 702 may be configured to transmit/provide, and the anchor cell 705 may be configured to receive, the request 710 for SSB activation. The request 710 for SSB activation may be associated with SSB activation at the NES cell 704. Accordingly, the anchor cell 705 may provide backhaul (BH) coordination signaling 712 to the NES cell 704 to forward the request to activate the set of SSB transmissions, as described herein for anchor cells and NES cells that in a same DU or in different DUs (e.g., where the anchor DU may forward requests via a CU that communicates via an F1-AP interface with the NES cell DU). Subsequent to the BH coordination signaling 712, the NES cell 704 may be configured as an SCell of the UE 702.

The UE 702 may be configured to receive, and the NES cell 704 may be configured to transmit/provide, the set of SSB transmissions (e.g., periodic SSB transmissions 714) based on an activation thereof, as described above. In aspects, the UE 702 may be configured to receive, from the NES cell 704 and based on the indication (e.g., the request 710) being indicative of the activation, the set of SSB transmissions (e.g., the periodic SSB transmissions 714). The periodic SSB transmissions 714 may be the set of SSB transmissions and may comprise at least one of a system information block type 1 (SIB1), a PRACH, or a remaining minimum SIB1 (RMSI). Aspects herein also provide for a request for SSB deactivation in place of the request 710 for SSB activation, which may result in the deactivation of the periodic SSB transmissions 714. Such deactivation may be similarly based on the location information 706 and the condition associated with the parameter-based relationship of the UE 702 and the NES cell 704.

In the context of FIG. 8, the UE 802 may be configured to transmit/provide, based on the condition being met, an indication (e.g., an UL-WUS 810 for SSB activation) associated with an activation or a deactivation of a set of SSB transmissions at the NES cell 804 (e.g., the first network node). In the illustrated aspect, the UE 802 may be configured to transmit/provide, and the NES cell 804 may be configured to receive, the UL-WUS 810. The UL-WUS 810 may be associated with SSB activation. Accordingly, the UL-WUS 810 may cause the NES cell 804 to activate the set of SSB transmissions, as described.

There may be impact to the UE 802 power consumption in FR2, as the UE 802 may repeat TX in the set of SSB transmissions as periodic SSB transmissions 812 for UL beam management, due to an absence of SSBs before transmission of the UL-WUS 810. As there are no SSB transmissions from the NES cell 804 prior to activation, TX timing of the UL-WUS 810 may be based on the UE 802 RX or TX timing for the anchor cell 805. The NES cell 804 may place a search window for reception of the UL-WUS 810. In some aspects, the UE 802 may adjust its TX timing based on its estimated (e.g., rough) location and additional assistance information provided by the network (e.g., via the anchor cell 805, a CU, etc.). TX power of the UL-WUS 810 may be based on any (combination of) a fixed value, an estimated PL/RSRP from the anchor cell 805, additional adjustment indicated by the anchor cell 805 or selected by the UE 802 (e.g., based on its estimated location and/or the extra assistance information). In aspects, the NES cell 804 may turn on SSB transmissions (e.g., the periodic SSB transmissions 812 (the set of SSB transmissions)) if the UL-WUS 810 can be detected, but otherwise may not turn on SSB transmissions. The illustrated aspect in call flow diagram 800 takes into account RF conditions via the UL measurement for turning on the periodic SSB transmissions 812, which may be different than aspects described above for call flow diagram 700 in FIG. 7 which may be based on location information to turn on SSB transmissions. In some aspects, after turning on/activating the periodic SSB transmissions 812 (the set of SSB transmissions) and configuring a measurement report call flow diagram 700 in FIG. 7, it may be realized that the NES cell may not be a suitable cell as/for an SCell due to poor RF conditions, which has a larger latency and network power consumption than the aspect illustrated in call flow diagram 800.

In aspects, the UL-WUS 810 may be associated with at least one of: at least one repeated transmission of the UL-WUS 810, a UE 802 signal timing associated with at least one of the anchor cell 805 (e.g., the second network node), an estimated location of the NES cell 804 (e.g., the network energy savings node), or assistance information of a radio network associated with the UE 802. In aspects, the UL-WUS 810 may be associated with a transmit power based on at least one of a fixed value, an estimated power level of a signal associated with the anchor cell 805 (e.g., the second network node), an estimated reference signal received power associated with the anchor cell 805 (e.g., the second network node), or an adjustment power associated with at least one of the UE 802 or the anchor cell 805 (e.g., the second network node). In aspects, the UL-WUS 810 may be associated with a PRACH. Subsequent to the UL-WUS 810, the NES cell 804 may be configured as an SCell of the UE 802.

The UE 802 may be configured to receive, and the NES cell 804 may be configured to transmit/provide, the set of SSB transmissions (e.g., the periodic SSB transmissions 812) based on an activation thereof, as described above. In aspects, the UE 802 may be configured to receive, from the NES cell 804 and based on the indication (e.g., the UL-WUS 810) being indicative of the activation, the set of SSB transmissions (e.g., the periodic SSB transmissions 812). The periodic SSB transmissions 812 may comprise at least one of a SIB1, a PRACH, or an RMSI. Aspects herein also provide for SSB deactivation via the UL-WUS 810 in place of the UL-WUS 810 for SSB activation, which may result in the deactivation of the periodic SSB transmissions 812. Such deactivation may be similarly based on the location information 806 and the condition associated with the parameter-based relationship of the UE 802 and the NES cell 804.

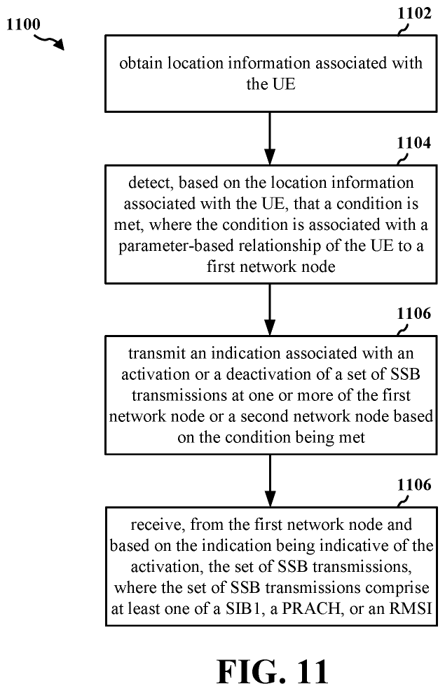

FIG. 11 is a flowchart 1100 of a method of wireless communication. The method may be performed by a UE (e.g., the UE 104, 702, 802, 902; the apparatus 1404). In some aspects, the method may include aspects described in connection with the communication flows in FIGS. 7, 8, 9, and/or aspects described in FIGS. 4-6. The method may be for on-demand SSB transmissions for NES cells based on location information. The method may enable the dynamic activation/deactivation of SSB transmissions of an NES node/cell associated with an anchor node by obtaining location information associated with a UE, e.g., from the UE or the anchor node, and enable reduced network energy expenditures in scenarios for which UEs are idle or not present in the coverage area of the NES node/cell by dynamically activating/deactivating the SSB transmissions of the NES node/cell associated with the anchor node.

At 1102, the UE obtains location information associated with the UE. As an example, the obtainment may be performed by one or more of the component 198, the transceiver(s) 1422, and/or the antenna 1480 in FIG. 14. FIG. 7 illustrates, in the context of FIG. 8, an example of the UE 702 obtaining such location information.

The UE 702 may be configured to obtain location information 706 associated with the UE 702. The UE may be configured to receive, and the anchor cell 705 may be configured to transmit/provide, the location information 706. The location information 706 may include one or more parameters by which condition for a parameter-based relationship between the UE 702 and the NES cell 704 may be detected/identified.

In aspects, the location information 706 may include history data associated with the UE 702, assistance information associated with the anchor cell 705 of the UE 702, and/or model information associated with an output of at least one of an artificial intelligence (AI) algorithm or a machine learning (ML) model and one or more respective inputs (e.g., at the UE 702). In some aspects, the location information may be based on a GNSS, a signaling positioning service of a radio network associated with the UE 702, and/or the like. In aspects, the history data may be based on a connection history between the UE 702 and the NES cell 704 (e.g., the first network node) that may show a correlation of the location of the UE 702 with coverage of the NES cell 704. In some aspects, the assistance information may be based on a cell location of the NES cell 704, a distance associated with the condition (e.g., a distance between the UE 702 and the NES cell 704 meeting a threshold condition to trigger a request for SSB activation, such as the distance being less than, or less than or equal to a threshold distance), one or more resources associated with the indication of the location information 706, and/or the like. In some aspects, the one or more respective inputs associated with the AI algorithm/the ML model may include a downlink measurement of a signal associated with the anchor cell 705, sensing information associated with the UE 702 (e.g., a camera picture of the environment for the UE 702), the location information 706, the cell location (e.g., of the NES cell 704), and/or the like.

At 1104, the UE detects, based on the location information associated with the UE, that a condition is met, where the condition is associated with a parameter-based relationship of the UE to a first network node. As an example, the detection may be performed by one or more of the component 198, the transceiver(s) 1422, and/or the antenna 1480 in FIG. 14. FIG. 7 illustrates, in the context of FIG. 8, an example of the UE 702 detecting such a condition associated with a parameter-based relationship of the UE 702 to a first network node (e.g., the NES cell 704).

The UE 702 may be configured to detect (at 708), based on the location information 706 associated with the UE 702, that a condition is met. As noted, the condition may be associated with a parameter-based relationship of the UE 702 to the NES cell 704 (e.g., the first network node), and may be based on one or more of the parameters described above. In aspects, the detection (at 708) may indicate that the UE 702 is within the coverage area of the NES cell 704.

At 1106, the UE transmits an indication associated with an activation or a deactivation of a set of SSB transmissions at one or more of the first network node or a second network node based on the condition being met. As an example, the transmission may be performed by one or more of the component 198, the transceiver(s) 1422, and/or the antenna 1480 in FIG. 14. FIGS. 7, 8 illustrate an example of the UE 702/the UE 802 transmitting/providing such an indication to the NES cell 704/804 and/or the anchor cell 705/805 and/or the base station 703/803.

In the context of FIG. 7, the UE 702 may be configured to transmit/provide, based on the condition being met, an indication (e.g., a request 710 for SSB activation) associated with an activation or a deactivation of a set of SSB transmissions at one or more of the NES cell 704 (e.g., the first network node) or the anchor cell 705 (e.g., the second network node, an anchor node, etc.). In the illustrated aspect, the UE 702 may be configured to transmit/provide, and the anchor cell 705 may be configured to receive, the request 710 for SSB activation. The request 710 for SSB activation may be associated with SSB activation at the NES cell 704. Accordingly, the anchor cell 705 may provide backhaul (BH) coordination signaling 712 to the NES cell 704 to forward the request to activate the set of SSB transmissions, as described herein for anchor cells and NES cells that in a same DU or in different DUs (e.g., where the anchor DU may forward requests via a CU that communicates via an F1-AP interface with the NES cell DU). Subsequent to the BH coordination signaling 712, the NES cell 704 may be configured as an SCell of the UE 702.

In the context of FIG. 8, the UE 802 may be configured to transmit/provide, based on the condition being met, an indication (e.g., an UL-WUS 810 for SSB activation) associated with an activation or a deactivation of a set of SSB transmissions at the NES cell 804 (e.g., the first network node). In the illustrated aspect, the UE 802 may be configured to transmit/provide, and the NES cell 804 may be configured to receive, the UL-WUS 810. The UL-WUS 810 may be associated with SSB activation. Accordingly, the UL-WUS 810 may cause the NES cell 804 to activate the set of SSB transmissions, as described.

There may be impact to the UE 802 power consumption in FR2, as the UE 802 may repeat TX in the set of SSB transmissions as periodic SSB transmissions 812 for UL beam management, due to an absence of SSBs before transmission of the UL-WUS 810. As there are no SSB transmissions from the NES cell 804 prior to activation, TX timing of the UL-WUS 810 may be based on the UE 802 RX or TX timing for the anchor cell 805. The NES cell 804 may place a search window for reception of the UL-WUS 810. In some aspects, the UE 802 may adjust its TX timing based on its estimated (e.g., rough) location and additional assistance information provided by the network (e.g., via the anchor cell 805, a CU, etc.). TX power of the UL-WUS 810 may be based on any (combination of) a fixed value, an estimated PL/RSRP from the anchor cell 805, additional adjustment indicated by the anchor cell 805 or selected by the UE 802 (e.g., based on its estimated location and/or the extra assistance information). In aspects, the NES cell 804 may turn on SSB transmissions (e.g., the periodic SSB transmissions 812 (the set of SSB transmissions)) if the UL-WUS 810 can be detected, but otherwise may not turn on SSB transmissions. The illustrated aspect in call flow diagram 800 takes into account RF conditions via the UL measurement for turning on the periodic SSB transmissions 812, which may be different than aspects described above for call flow diagram 700 in FIG. 7 which may be based on location information to turn on SSB transmissions. In some aspects, after turning on/activating the periodic SSB transmissions 812 (the set of SSB transmissions) and configuring a measurement report call flow diagram 700 in FIG. 7, it may be realized that the NES cell may not be a suitable cell as/for an SCell due to poor RF conditions, which has a larger latency and network power consumption than the aspect illustrated in call flow diagram 800.

In aspects, the UL-WUS 810 may be associated with at least one of: at least one repeated transmission of the UL-WUS 810, a UE 802 signal timing associated with at least one of the anchor cell 805 (e.g., the second network node), an estimated location of the NES cell 804 (e.g., the network energy savings node), or assistance information of a radio network associated with the UE 802. In aspects, the UL-WUS 810 may be associated with a transmit power based on at least one of a fixed value, an estimated power level of a signal associated with the anchor cell 805 (e.g., the second network node), an estimated reference signal received power associated with the anchor cell 805 (e.g., the second network node), or an adjustment power associated with at least one of the UE 802 or the anchor cell 805 (e.g., the second network node). In aspects, the UL-WUS 810 may be associated with a PRACH. Subsequent to the UL-WUS 810, the NES cell 804 may be configured as an SCell of the UE 802.

At 1108, the UE receive, from the first network node and based on the indication being indicative of the activation, the set of SSB transmissions, where the set of SSB transmissions comprise at least one of a SIB1, a PRACH, or an RMSI. As an example, the reception may be performed by one or more of the component 198, the transceiver(s) 1422, and/or the antenna 1480 in FIG. 14. FIGS. 7, 8 illustrate an example of the UE 702/the UE 802 receiving such an indication from a first network node (e.g., the NES cell 704).

In the context of FIG. 7, the UE 702 may be configured to receive, and the NES cell 704 may be configured to transmit/provide, the set of SSB transmissions (e.g., periodic SSB transmissions 714) based on an activation thereof, as described above. In aspects, the UE 702 may be configured to receive, from the NES cell 704 and based on the indication (e.g., the request 710) being indicative of the activation, the set of SSB transmissions (e.g., the periodic SSB transmissions 714). The periodic SSB transmissions 714 may be the set of SSB transmissions and may comprise at least one of a system information block type 1 (SIB1), a PRACH, or a remaining minimum SIB1 (RMSI). Aspects herein also provide for a request for SSB deactivation in place of the request 710 for SSB activation, which may result in the deactivation of the periodic SSB transmissions 714. Such deactivation may be similarly based on the location information 706 and the condition associated with the parameter-based relationship of the UE 702 and the NES cell 704.

In the context of FIG. 8, the UE 802 may be configured to receive, and the NES cell 804 may be configured to transmit/provide, the set of SSB transmissions (e.g., the periodic SSB transmissions 812) based on an activation thereof, as described above. In aspects, the UE 802 may be configured to receive, from the NES cell 804 and based on the indication (e.g., the UL-WUS 810) being indicative of the activation, the set of SSB transmissions (e.g., the periodic SSB transmissions 812). The periodic SSB transmissions 812 may comprise at least one of a SIB1, a PRACH, or an RMSI. Aspects herein also provide for SSB deactivation via the UL-WUS 810 in place of the UL-WUS 810 for SSB activation, which may result in the deactivation of the periodic SSB transmissions 812. Such deactivation may be similarly based on the location information 806 and the condition associated with the parameter-based relationship of the UE 802 and the NES cell 804.

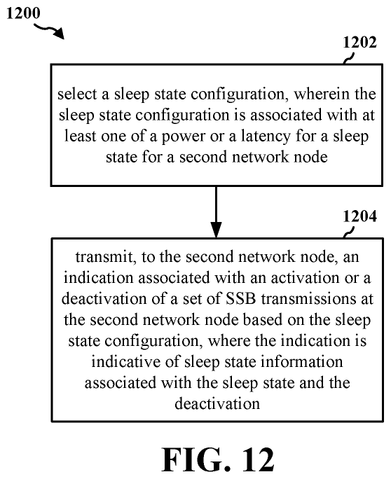

FIG. 12 is a flowchart 1200 of a method of wireless communication. The method may be performed by a network entity/network node (e.g., the base station 102, 703, 803, 904; the CU 910; the network entity 1502). In some aspects, the method may include aspects described in connection with the communication flows in FIGS. 7, 8, 9, and/or aspects described in FIGS. 4-6. The method may be for on-demand SSB transmissions for NES cells based on location information. The method may enable the dynamic activation/deactivation of SSB transmissions of an NES node/cell associated with an anchor node by obtaining location information associated with a UE, e.g., from the UE or the anchor node, and enable reduced network energy expenditures in scenarios for which UEs are idle or not present in the coverage area of the NES node/cell by dynamically activating/deactivating the SSB transmissions of the NES node/cell associated with the anchor node.

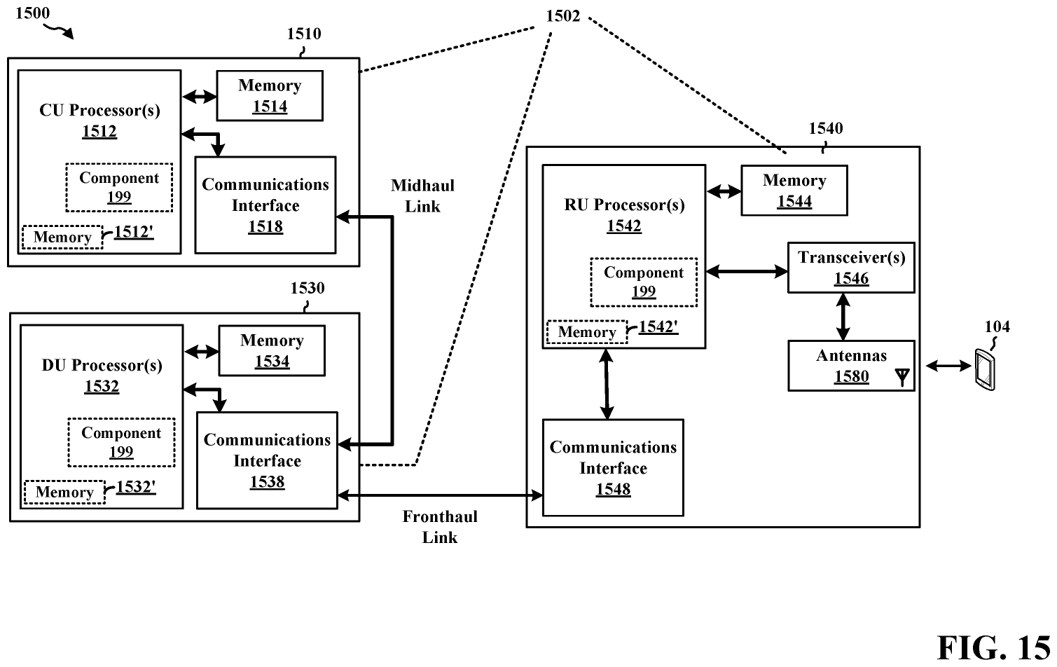

At 1202, the first network node selects a sleep state configuration, where the sleep state configuration is associated with at least one of a power or a latency for a sleep state for a second network node. As an example, the detection may be performed by one or more of the component 199, the transceiver(s) 1546, and/or the antenna 1580 in FIG. 15. FIG. 9 illustrates an example of the CU 910 detecting such a condition associated with a parameter-based relationship of a UE (e.g., the UE 902) to a second network node (e.g., the NES cell 908).

The CU 910 may be configured to receive, and the NES cell 908 may be configured to transmit/provide, a capability indication 916. The capability indication 916 may be indicative of support of the NES cell 908 (e.g., the second network node) for at least one of a set of sleep state types, a set of respective expected durations of the set of sleep state types, or a set of respective minimum durations of the set of sleep state types. In aspects, the CU 910 may be configured to transmit/provide, and the NES cell 908 may be configured to receive (e.g., as a second network node), an indication (e.g., a DU configuration update 920, a DU configuration update 932) that is associated with an activation or a deactivation of a set of SSB transmissions at the NES cell 908, and such an indication(s) may be associated with and/or based on the capability indication 916.

The CU 910 may be configured to request to turn on/off a set of SSB transmissions (e.g., periodic SSB transmissions) of the NES cell 908 based on the location of the UE 902 that is obtained from an RRM measurement report from the UE 902 (e.g., from a measurement(s) of a DL RS). In one example, a rough/estimated location of the UE 902 may be obtained by the CU 910 via the anchor cell 906 from a beam level report included in the RRM measurement report (e.g., an SSB or CSI-RS resource index, RSRP). In some examples, location information obtained from a GNSS by the UE 902 side may also be included inside the RRM measurement report when configured.

In the existing F1-AP interface, the CU 910 may send a gNB-CU configuration update message, as an indication associated with an activation or a deactivation of a set of SSB transmissions (e.g., the periodic SSB transmissions 922), to a DU to request the cell activation/deactivation (e.g., the DU configuration update 920 (for activation), the DU configuration update 932 (for deactivation)). In some examples, the cell activation may be enhanced to include activation of a list of SSBs. If a list of SSBs is not included, the cell activation may turn on all SSBs, and the cell deactivation may turn off all SSBs. In the illustrated example, based on at least on the RRM measurement report, the CU 910 may be configured to select a sleep state configuration and to turn on/activate (at 918) the periodic SSB transmissions 922 (e.g., a set of SSB transmissions) at the NES cell 908. The sleep state configuration may be based on/associated with at least one of a power or a latency for a sleep state for a second network node (e.g., the NES cell 908). In aspects, to turn off/deactivate the periodic SSB transmissions 922 (e.g., a set of SSB transmissions) at the NES cell 908, the CU 910 may be configured to receive, from the second network node (e.g., the NES cell 908), a deactivation request 928 (described below) associated with the activation (e.g., via the DU configuration update 920) of the set of SSB transmissions (e.g., the periodic SSB transmissions 922), where the deactivation request 928 may be based on at least one of the expected duration of the sleep state, the minimum duration of the sleep state, or a cell indication indicative of NES cell 908 (e.g., the second network node) remaining unconfigured as a secondary cell (SCell) of the UE 902. In some aspects, the CU 910 may be configured to receive, from the UE 902, the deactivation request 928 in addition to, or in lieu of, reception from the NES cell 908.

As described, the CU 910 may be configured to transmit/provide, and the NES cell 908 may be configured to receive (e.g., as a second network node), an indication associated with an activation or a deactivation of a set of SSB transmissions, such as the DU configuration update 920, e.g., for cell activation. The indication/DU configuration update 920 may be indicative of sleep state information. In aspects, the sleep state information may include, without limitation, at least one of a type of a sleep state, an expected duration of the sleep state, a minimum duration of the sleep state, and/or the like. In aspects, a portion of the sleep state information indicated by the indication/DU configuration update may be implicitly indicated based on at least one of a prior sleep state configuration, a fixed sleep state configuration, or a semi-static sleep state configuration. In some aspects, the indication/DU configuration update 920 may be associated with at least one of: an entire cell of the NES cell 908 (e.g., the second network node), a per beam configuration, a set of beams, a set of signal directions, a set of coverage areas, a set of zones, and/or the like. Upon cell activation, the NES cell 908 may configured to provide the periodic SSB transmissions 922 (e.g., the set of SSB transmissions) to the UE 902, and the CU 910 may be configured to subsequently provide a configuration(s) 924 to the UE 902 for RRM measurements for the NES cell 908, to add/remove the NES cell 908 as an SCell, etc.

As described, the CU 910 may be configured to turn off/deactivate of a set of SSB transmissions (e.g., the periodic SSB transmissions 922) at the NES cell 908. For example, the CU 910 may be configured to select (at 926) a sleep state configuration associated with at least one of a power or a latency for a sleep state for the NES cell 908 (e.g., a second network node), and to turn off/deactivate the periodic SSB transmissions 922 (the set of SSB transmissions) at the NES cell 908. In aspects, the selection/deactivation (at 926) may be based on the deactivation request 928, described above, and/or on be based on at least one of the expected duration of the sleep state, the minimum duration of the sleep state, or a cell indication indicative of NES cell 908 (e.g., the second network node) remaining unconfigured as an SCell of the UE 902 as otherwise determined by the CU 910.

At 1204, the first network node transmits, to the second network node, an indication associated with an activation or a deactivation of a set of SSB transmissions at the second network node based on the sleep state configuration, where the indication is indicative of sleep state information associated with the sleep state and the deactivation. As an example, the transmission may be performed by one or more of the component 199, the transceiver(s) 1546, and/or the antenna 1580 in FIG. 15. FIG. 9 illustrates an example of the CU 910 transmitting such an indication associated with an activation or a deactivation of the set of SSB transmissions at the second network node (e.g., the NES cell 908).

The deactivation determination for the selection/deactivation (at 926) may be followed by the CU 910 transmitting/providing the DU configuration update 932 (e.g., as an indication, based on the sleep state configuration, for deactivation) to the NES cell 908. The NES cell 908 may be configured to deactivate (at 930) the periodic SSB transmission 922 (e.g., the set of SSB transmissions). In aspects, such a deactivation (at 930) may be based on the DU configuration update 932 (for deactivation), the sleep state information, and/or at least one of a prior sleep state configuration, a fixed sleep state configuration, or a semi-static sleep state configuration (e.g., which may be for the minimum duration). The DU may turn off the periodic SSB transmissions 922 (the set of SSB transmissions) or deactivate the NES cell 908 (or send the deactivation request 928 to the CU 910) after expiry of the associated duration. This may be further dependent on additional criteria, such as but not limited to: deactivation may be allowed if by the end of expiry time, the NES cell 908 has not been added/configured as an SCell for a UE 902. In one example, the CU 910 may be configured to explicitly indicate for (at least) how long the DU should keep the NES cell 908 actively transmitting the periodic SSB transmissions 922 (the set of SSB transmissions). In some aspects, the DU may determine the sleep state during the deactivated state of the NES cell 908 based on an implementation thereof.

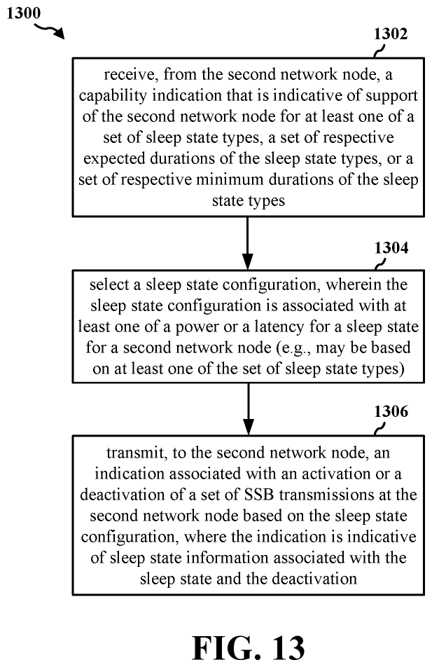

FIG. 13 is a flowchart 1300 of a method of wireless communication. The method may be performed by a network entity/network node (e.g., the base station 102, 703, 803, 904; the CU 910; the network entity 1502). In some aspects, the method may include aspects described in connection with the communication flows in FIGS. 7, 8, 9, and/or aspects described in FIGS. 4-6. The method may be for on-demand SSB transmissions for NES cells based on location information. The method may enable the dynamic activation/deactivation of SSB transmissions of an NES node/cell associated with an anchor node by obtaining location information associated with a UE, e.g., from the UE or the anchor node, and enable reduced network energy expenditures in scenarios for which UEs are idle or not present in the coverage area of the NES node/cell by dynamically activating/deactivating the SSB transmissions of the NES node/cell associated with the anchor node.

At 1302, the first network node detects that a condition is met, where the condition is associated with a parameter-based relationship of a UE to a second network node. As an example, the detection may be performed by one or more of the component 199, the transceiver(s) 1546, and/or the antenna 1580 in FIG. 15. FIG. 9 illustrates an example of the CU 910 detecting such a condition associated with a parameter-based relationship of a UE (e.g., the UE 902) to a second network node (e.g., the NES cell 908).

The CU 910 may be configured to receive, and the NES cell 908 may be configured to transmit/provide, a capability indication 916. The capability indication 916 may be indicative of support of the NES cell 908 (e.g., the second network node) for at least one of a set of sleep state types, a set of respective expected durations of the set of sleep state types, or a set of respective minimum durations of the set of sleep state types. In aspects, the CU 910 may be configured to transmit/provide, and the NES cell 908 may be configured to receive (e.g., as a second network node), an indication (e.g., a DU configuration update 920, a DU configuration update 932) that is associated with an activation or a deactivation of a set of SSB transmissions at the NES cell 908, and such an indication(s) may be associated with and/or based on the capability indication 916.

At 1304, the first network node selects a sleep state configuration, where the sleep state configuration is associated with at least one of a power or a latency for a sleep state for a second network node. As an example, the detection may be performed by one or more of the component 199, the transceiver(s) 1546, and/or the antenna 1580 in FIG. 15. FIG. 9 illustrates an example of the CU 910 detecting such a condition associated with a parameter-based relationship of a UE (e.g., the UE 902) to a second network node (e.g., the NES cell 908).

The CU 910 may be configured to request to turn on/off the set of SSB transmissions (e.g., a periodic SSB) of the NES cell 908 based on the location of the UE 902 that is obtained from an RRM measurement report from the UE 902 (e.g., from a measurement(s) of a DL RS). In one example, a rough/estimated location of the UE 902 may be obtained by the CU 910 via the anchor cell 906 from a beam level report included in the RRM measurement report (e.g., an SSB or CSI-RS resource index, RSRP). In some examples, location information obtained from a GNSS by the UE 902 side may also be included inside the RRM measurement report when configured.

In the existing F1-AP interface, the CU 910 may send a gNB-CU configuration update message, as an indication associated with an activation or a deactivation of a set of SSB transmissions (e.g., the periodic SSB transmissions 922), to a DU to request the cell activation/deactivation (e.g., the DU configuration update 920 (for activation), the DU configuration update 932 (for deactivation)). In some examples, the cell activation may be enhanced to include activation of a list of SSBs. If a list of SSBs is not included, the cell activation may turn on all SSBs, and the cell deactivation may turn off all SSBs. In the illustrated example, based on at least on the RRM measurement report, the CU 910 may be configured to select a sleep state configuration and to turn on/activate (at 918) the periodic SSB transmissions 922 (e.g., a set of SSB transmissions) at the NES cell 908. The sleep state configuration may be based on/associated with at least one of a power or a latency for a sleep state for a second network node (e.g., the NES cell 908). In aspects, to turn off/deactivate the periodic SSB transmissions 922 (e.g., a set of SSB transmissions) at the NES cell 908, the CU 910 may be configured to receive, from the second network node (e.g., the NES cell 908), a deactivation request 928 (described below) associated with the activation (e.g., via the DU configuration update 920) of the set of SSB transmissions (e.g., the periodic SSB transmissions 922), where the deactivation request 928 may be based on at least one of the expected duration of the sleep state, the minimum duration of the sleep state, or a cell indication indicative of NES cell 908 (e.g., the second network node) remaining unconfigured as a secondary cell (SCell) of the UE 902. In some aspects, the CU 910 may be configured to receive, from the UE 902, the deactivation request 928 in addition to, or in lieu of, reception from the NES cell 908.

As described, the CU 910 may be configured to transmit/provide, and the NES cell 908 may be configured to receive (e.g., as a second network node), an indication associated with an activation or a deactivation of a set of SSB transmissions, such as the DU configuration update 920, e.g., for cell activation. The indication/DU configuration update 920 may be indicative of sleep state information. In aspects, the sleep state information may include, without limitation, at least one of a type of a sleep state, an expected duration of the sleep state, a minimum duration of the sleep state, and/or the like. In aspects, a portion of the sleep state information indicated by the indication/DU configuration update may be implicitly indicated based on at least one of a prior sleep state configuration, a fixed sleep state configuration, or a semi-static sleep state configuration. In some aspects, the indication/DU configuration update 920 may be associated with at least one of: an entire cell of the NES cell 908 (e.g., the second network node), a per beam configuration, a set of beams, a set of signal directions, a set of coverage areas, a set of zones, and/or the like. Upon cell activation, the NES cell 908 may configured to provide the periodic SSB transmissions 922 (e.g., the set of SSB transmissions) to the UE 902, and the CU 910 may be configured to subsequently provide a configuration(s) 924 to the UE 902 for RRM measurements for the NES cell 908, to add/remove the NES cell 908 as an SCell, etc.

As described, the CU 910 may be configured to turn off/deactivate of a set of SSB transmissions (e.g., the periodic SSB transmissions 922) at the NES cell 908. For example, the CU 910 may be configured to select (at 926) a sleep state configuration associated with at least one of a power or a latency for a sleep state for the NES cell 908 (e.g., a second network node), and to turn off/deactivate the periodic SSB transmissions 922 (the set of SSB transmissions) at the NES cell 908. In aspects, the selection/deactivation (at 926) may be based on the deactivation request 928, described above, and/or on be based on at least one of the expected duration of the sleep state, the minimum duration of the sleep state, or a cell indication indicative of NES cell 908 (e.g., the second network node) remaining unconfigured as an SCell of the UE 902 as otherwise determined by the CU 910.

At 1306, the first network node transmits, to the second network node, an indication associated with an activation or a deactivation of a set of SSB transmissions at the second network node based on the sleep state configuration, where the indication is indicative of sleep state information associated with the sleep state and the deactivation. As an example, the transmission may be performed by one or more of the component 199, the transceiver(s) 1546, and/or the antenna 1580 in FIG. 15. FIG. 9 illustrates an example of the CU 910 transmitting such an indication associated with an activation or a deactivation of the set of SSB transmissions at the second network node (e.g., the NES cell 908).

The deactivation determination for the selection/deactivation (at 926) may be followed by the CU 910 transmitting/providing the DU configuration update 932 (e.g., as an indication, based on the sleep state configuration, for deactivation) to the NES cell 908. The NES cell 908 may be configured to deactivate (at 930) the periodic SSB transmission 922 (e.g., the set of SSB transmissions). In aspects, such a deactivation (at 930) may be based on the DU configuration update 932 (for deactivation), the sleep state information, and/or at least one of a prior sleep state configuration, a fixed sleep state configuration, or a semi-static sleep state configuration (e.g., which may be for the minimum duration). The DU may turn off the periodic SSB transmissions 922 (the set of SSB transmissions) or deactivate the NES cell 908 (or send the deactivation request 928 to the CU 910) after expiry of the associated duration. This may be further dependent on additional criteria, such as but not limited to: deactivation may be allowed if by the end of expiry time, the NES cell 908 has not been added/configured as an SCell for a UE 902. In one example, the CU 910 may be configured to explicitly indicate for (at least) how long the DU should keep the NES cell 908 actively transmitting the periodic SSB transmissions 922 (the set of SSB transmissions). In some aspects, the DU may determine the sleep state during the deactivated state of the NES cell 908 based on an implementation thereof.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to obtain location information associated with the UE. The component 198 may also be configured to detect, based on the location information associated with the UE, that a condition is met, where the condition is associated with a parameter-based relationship of the UE to a first network node. The component 198 may also be configured to transmit, based on the condition being met, an indication associated with an activation or a deactivation of a set of SSB transmissions at one or more of the first network node or a second network node. The component 198 may also be configured to receive, from the first network node and based on the indication being indicative of the activation, the set of SSB transmissions, where the set of SSB transmissions comprises at least one of a SIB1, a PRACH, or an RMSI. The component 198 may be further configured to perform any of the aspects described in connection with the flowcharts in any of FIGS. 10, 11, 12, 13, and/or any of the aspects performed by a UE for any of FIGS. 4-7. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for obtaining location information associated with the UE. In the configuration, the apparatus 1404, and in particular the cellular baseband processor(s) 1424 and/or the application processor(s) 1406, may include means for detecting, based on the location information associated with the UE, that a condition is met, where the condition is associated with a parameter-based relationship of the UE to a first network node. In the configuration, the apparatus 1404, and in particular the cellular baseband processor(s) 1424 and/or the application processor(s) 1406, may include means for transmitting, based on the condition being met, an indication associated with an activation or a deactivation of a set of SSB transmissions at one or more of the first network node or a second network node. In one configuration, the apparatus 1404, and in particular the cellular baseband processor(s) 1424 and/or the application processor(s) 1406, may include means for receiving, from the first network node and based on the indication being indicative of the activation, the set of SSB transmissions, where the set of SSB transmissions comprises at least one of a SIB1, a PRACH, or an RMSI. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to select a sleep state configuration, where the sleep state configuration is associated with at least one of a power or a latency for a sleep state for a second network node. The component 199 may also be configured to transmit, to the second network node and based on the sleep state configuration, an indication associated with an activation or a deactivation of a set of SSB transmissions at the second network node, where the indication is indicative of sleep state information associated with the sleep state and the deactivation. The component 199 may also be configured to receive, from the second network node, a capability indication that is indicative of support of the second network node for at least one of a set of sleep state types, a set of respective expected durations of the set of sleep state types, or a set of respective minimum durations of the set of sleep state types, where selecting the sleep state configuration is based on at least one of the set of sleep state types. The component 199 may be further configured to perform any of the aspects described in connection with the flowcharts in any of FIGS. 10, 11, 12, 13, and/or any of the aspects performed by a network entity/network node for any of FIGS. 4-9. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for detecting that a condition is met, where the condition is associated with a parameter-based relationship of a UE to a second network node. In the configuration, the network entity 1502 may include means for transmitting, to the second network node and based on the condition being met, an indication associated with an activation or a deactivation of a set of SSB transmissions at the second network node, where the indication is indicative of sleep state information associated with the deactivation. In one configuration, the network entity 1502 may include means for receiving, from the second network node, a capability indication that is indicative of support of the second network node for at least one of a set of sleep state types, a set of respective expected durations of the set of sleep state types, or a set of respective minimum durations of the set of sleep state types. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

A network node and a UE in a wireless communication network may communicate in various configurations and using various communication schema to conserve power and energy in the network. One example communication scheme to conserve network energy utilizes an NES cell(s) for on-demand SSB transmission for SCell for connected UEs. In such solutions, triggering methods for on-demand SSB transmission may be utilized (e.g., a UE UL wake-up signal using an existing signal/channel, cell on/off indications via backhaul, SCell activation/deactivation signaling, etc.). However, as NES cells are within the coverage area of an anchor cell and may be added as SCells for connected UEs, energy savings issues may arise due to the lack of support for idle UEs. That is, when idle UEs, or no UEs, are within the range of an NES cell, the NES cell may continue to provide SSB transmissions and expend network power/energy. Further to this issue, without SSB transmissions from an NES cell, there is no measurement between the NES and a UE to discover whether the UE is within cell coverage of the NES cell.

Aspects described herein for on-demand SSB transmissions for NES cells based on location information provide solutions to such issues. As one example, aspects enable the dynamic activation/deactivation of SSB transmissions of an NES node/cell associated with an anchor node by obtaining location information associated with a UE, e.g., from the UE or the anchor node. As another example, aspects enable reduced network energy expenditures in scenarios for which UEs are idle or not present in the coverage area of the NES node/cell by dynamically activating/deactivating the SSB transmissions of the NES node/cell associated with the anchor node.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: obtaining location information associated with the UE; detecting, based on the location information associated with the UE, that a condition is met, wherein the condition is associated with a parameter-based relationship of the UE to a first network node; and transmitting, based on the condition being met, an indication associated with an activation or a deactivation of a set of synchronization signal block (SSB) transmissions at one or more of the first network node or a second network node.

Aspect 2 is the method of aspect 1, wherein transmitting the indication associated with the activation or the deactivation of the set of SSB transmissions at one or more of the first network node or the second network node includes transmitting the indication to the second network node that is different from the first network node, wherein the second network node is an anchor node associated with the UE.

Aspect 3 is the method of aspect 2, wherein transmitting the indication to the second network node includes transmitting the indication to the first network node via the second network node and backhaul coordination.

Aspect 4 is the method of aspect 1, wherein transmitting the indication associated with the activation or the deactivation of the set of SSB transmissions at one or more of the first network node or the second network node includes transmitting the indication to the first network node, wherein the first network node is a network energy savings node associated with the UE.

Aspect 5 is the method of aspect 4, wherein transmitting the indication to the first network node includes transmitting an uplink wake-up signal (UL-WUS) to the first network node.

Aspect 6 is the method of aspect 5, wherein the UL-WUS is associated with at least one of: at least one repeated transmission of the UL-WUS, a UE signal timing associated with at least one of the second network node, an estimated location of the network energy savings node, or assistance information of a radio network associated with the UE, or a transmit power based on at least one of a fixed value, an estimated power level of a signal associated with the second network node, an estimated reference signal received power associated with the second network node, or an adjustment power associated with at least one of the UE or the second network node.

Aspect 7 is the method of aspect 6, wherein the UL-WUS is associated with a physical random access channel (PRACH).

Aspect 8 is the method of any of aspects 1 to 7, wherein the UE is a connected UE and the first network node is a secondary cell of the UE.

Aspect 9 is the method of any of aspects 1 to 8, wherein obtaining the location information includes obtaining at least one of history data associated with the UE, assistance information associated with an anchor cell of the UE, or model information associated with an output of at least one of an artificial intelligence (AI) algorithm or a machine learning (ML) model and one or more respective inputs.

Aspect 10 is the method of aspect 9, wherein the location information is based on at least one of a global navigation satellite system (GNSS) or a signaling positioning service of a radio network associated with the UE, wherein the history data is based on a connection history between the UE and the first network node, wherein the assistance information is based on a cell location of the first network node, a distance associated with the condition, or one or more resources associated with the indication, or wherein the one or more respective inputs include at least one of a downlink measurement of a signal associated with the anchor cell, sensing information associated with the UE, the location information, or the cell location.

Aspect 11 is the method of any of aspects 1 to 10, further comprising: receiving, from the first network node and based on the indication being indicative of the activation, the set of SSB transmissions, wherein the set of SSB transmissions comprises at least one of a system information block type 1 (SIB1), a physical random access channel (PRACH), or a remaining minimum SIB1 (RMSI).

Aspect 12 is a method of wireless communication at a first network node, comprising: selecting a sleep state configuration, wherein the sleep state configuration is associated with at least one of a power or a latency for a sleep state for a second network node; and transmitting, to the second network node based on the sleep state configuration, an indication associated with an activation or a deactivation of a set of synchronization signal block (SSB) transmissions at the second network node, wherein the indication is indicative of sleep state information associated with the sleep state and the deactivation.

Aspect 13 is the method of aspect 12, wherein the sleep state information includes at least one of a type of the sleep state, an expected duration of the sleep state, or a minimum duration of the sleep state.

Aspect 14 is the method of aspect 13, wherein a portion of the sleep state information is implicitly indicated based on at least one of a prior sleep state configuration, a fixed sleep state configuration, or a semi-static sleep state configuration.

Aspect 15 is the method of aspect 13, wherein selecting the sleep state configuration includes receiving, from the second network node, a deactivation request associated with the activation of the set of SSB transmissions, wherein the deactivation request is based on at least one of the expected duration of the sleep state, the minimum duration of the sleep state, or a cell indication indicative of the second network node remaining unconfigured as a secondary cell of a user equipment (UE).

Aspect 16 is the method of any of aspects 12 to 15, wherein selecting the sleep state configuration includes receiving, from a user equipment (UE), the indication associated with the activation or the deactivation of the set of SSB transmissions at the second network node.

Aspect 17 is the method of any of aspects 12 to 16, further comprising: receiving, from the second network node, a capability indication that is indicative of support of the second network node for at least one of a set of sleep state types, a set of respective expected durations of the set of sleep state types, or a set of respective minimum durations of the set of sleep state types, wherein selecting the sleep state configuration is based on at least one of the set of sleep state types.

Aspect 18 is the method of aspect 17, wherein the indication is associated with at least one of: an entire cell of the second network node, a per beam configuration, a set of beams, a set of signal directions, a set of coverage areas, or a set of zones.

Aspect 19 is the method of any of aspects 12 to 18, wherein the indication is associated with the activation of the set of SSB transmissions at the second network node, wherein the second network node comprises at least one of a secondary cell associated with a user equipment (UE) or a network energy savings node associated with the UE.

Aspect 20 is an apparatus for wireless communication at a user equipment (UE), comprising: at least one memory; and at least one processor coupled to the at least one memory, the at least one processor, individually or in any combination, is configured to perform the method of any of aspects 1 to 11.

Aspect 21 is an apparatus for wireless communication at a user equipment (UE), comprising means for performing each step in the method of any of aspects 1 to 11.

Aspect 22 is the apparatus of any of aspects 20 and 21, further comprising a transceiver configured to receive or to transmit in association with the method of any of aspects 1 to 11.

Aspect 23 is a computer-readable medium (e.g., a non-transitory computer-readable medium) storing computer executable code at a user equipment (UE), the code when executed by at least one processor causes the at least one processor to perform the method of any of aspects 1 to 11.

Aspect 24 is an apparatus for wireless communication at a first network node, comprising: at least one memory; and at least one processor coupled to the at least one memory, the at least one processor, individually or in any combination, is configured to perform the method of any of aspects 12 to 19.

Aspect 25 is an apparatus for wireless communication at a first network node, comprising means for performing each step in the method of any of aspects 12 to 19.

Aspect 26 is the apparatus of any of aspects 24 and 25, further comprising a transceiver configured to receive or to transmit in association with the method of any of aspects 12 to 19.

Aspect 27 is a computer-readable medium (e.g., a non-transitory computer-readable medium) storing computer executable code at a first network node, the code when executed by at least one processor causes the at least one processor to perform the method of any of aspects 12 to 19.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
obtain location information associated with the UE;
detect, based on the location information associated with the UE, that a condition is met, wherein the condition is associated with a parameter-based relationship of the UE to a first network node; and
transmit, based on the condition being met, an indication associated with an activation or a deactivation of a set of synchronization signal block (SSB) transmissions at one or more of the first network node or a second network node.

2. The apparatus of claim 1, wherein to transmit the indication associated with the activation or the deactivation of the set of SSB transmissions at one or more of the first network node or the second network node, the at least one processor, individually or in any combination, is configured to transmit the indication to the second network node that is different from the first network node, wherein the second network node is an anchor node associated with the UE.

3. The apparatus of claim 2, wherein to transmit the indication to the second network node, the at least one processor, individually or in any combination, is configured to transmit the indication to the first network node via the second network node and backhaul coordination.

4. The apparatus of claim 1, wherein to transmit the indication associated with the activation or the deactivation of the set of SSB transmissions at one or more of the first network node or the second network node, the at least one processor, individually or in any combination, is configured to transmit the indication to the first network node, wherein the first network node is a network energy savings node associated with the UE.

5. The apparatus of claim 4, wherein to transmit the indication to the first network node, the at least one processor, individually or in any combination, is configured to transmit an uplink wake-up signal (UL-WUS) to the first network node.

6. The apparatus of claim 5, wherein the UL-WUS is associated with at least one of:
at least one repeated transmission of the UL-WUS,
a UE signal timing associated with at least one of the second network node, an estimated location of the network energy savings node, or assistance information of a radio network associated with the UE, or
a transmit power based on at least one of a fixed value, an estimated power level of a signal associated with the second network node, an estimated reference signal received power associated with the second network node, or an adjustment power associated with at least one of the UE or the second network node.

7. The apparatus of claim 6, wherein the UL-WUS is associated with a physical random access channel (PRACH).

8. The apparatus of claim 1, wherein the UE is a connected UE and the first network node is a secondary cell of the UE.

9. The apparatus of claim 1, wherein to obtain the location information, the at least one processor, individually or in any combination, is configured to obtain at least one of history data associated with the UE, assistance information associated with an anchor cell of the UE, or model information associated with an output of at least one of an artificial intelligence (AI) algorithm or a machine learning (ML) model and one or more respective inputs.

10. The apparatus of claim 9, wherein the location information is based on at least one of a global navigation satellite system (GNSS) or a signaling positioning service of a radio network associated with the UE,
wherein the history data is based on a connection history between the UE and the first network node,
wherein the assistance information is based on a cell location of the first network node, a distance associated with the condition, or one or more resources associated with the indication, or
wherein the one or more respective inputs include at least one of a downlink measurement of a signal associated with the anchor cell, sensing information associated with the UE, the location information, or the cell location.

11. The apparatus of claim 1, further comprising at least one transceiver coupled to the at least one processor, wherein the at least one processor, individually or in any combination, is configured to:
receive, via the at least one transceiver, from the first network node and based on the indication being indicative of the activation, the set of SSB transmissions, wherein the set of SSB transmissions comprises at least one of a system information block type 1 (SIB1), a physical random access channel (PRACH), or a remaining minimum SIB1 (RMSI).

12. An apparatus for wireless communication at a first network node, comprising:
at least one memory; and
at least one processor coupled to the at least one memory and, based at least in part on information stored in the at least one memory, the at least one processor, individually or in any combination, is configured to:
select a sleep state configuration, wherein the sleep state configuration is associated with at least one of a power or a latency for a sleep state for a second network node; and
transmit, to the second network node based on the sleep state configuration, an indication associated with an activation or a deactivation of a set of synchronization signal block (SSB) transmissions at the second network node, wherein the indication is indicative of sleep state information associated with the sleep state and the deactivation.

13. The apparatus of claim 12, wherein the sleep state information includes at least one of a type of the sleep state, an expected duration of the sleep state, or a minimum duration of the sleep state.

14. The apparatus of claim 13, wherein a portion of the sleep state information is implicitly indicated based on at least one of a prior sleep state configuration, a fixed sleep state configuration, or a semi-static sleep state configuration.

15. The apparatus of claim 13, wherein to select the sleep state configuration, the at least one processor, individually or in any combination, is configured to receive, from the second network node, a deactivation request associated with the activation of the set of SSB transmissions, wherein the deactivation request is based on at least one of the expected duration of the sleep state, the minimum duration of the sleep state, or a cell indication indicative of the second network node remaining unconfigured as a secondary cell of a user equipment (UE).

16. The apparatus of claim 12, wherein to select the sleep state configuration, the at least one processor, individually or in any combination, is configured to receive, from a user equipment (UE), the indication associated with the activation or the deactivation of the set of SSB transmissions at the second network node.

17. The apparatus of claim 12, further comprising at least one transceiver coupled to the at least one processor, wherein the at least one processor, individually or in any combination, is configured to:
receive, via the at least one transceiver from the second network node, a capability indication that is indicative of support of the second network node for at least one of a set of sleep state types, a set of respective expected durations of the set of sleep state types, or a set of respective minimum durations of the set of sleep state types, wherein to select the sleep state configuration, the at least one processor, individually or in any combination, is configured to select the sleep state configuration based on at least one of the set of sleep state types.

18. The apparatus of claim 17, wherein the indication is associated with at least one of: an entire cell of the second network node, a per beam configuration, a set of beams, a set of signal directions, a set of coverage areas, or a set of zones.

19. The apparatus of claim 12, wherein the indication is associated with the activation of the set of SSB transmissions at the second network node, wherein the second network node comprises at least one of a secondary cell associated with a user equipment (UE) or a network energy savings node associated with the UE.

20. A method of wireless communication at a user equipment (UE), comprising:
obtaining location information associated with the UE;
detecting, based on the location information associated with the UE, that a condition is met, wherein the condition is associated with a parameter-based relationship of the UE to a first network node; and
transmitting, based on the condition being met, an indication associated with an activation or a deactivation of a set of synchronization signal block (SSB) transmissions at one or more of the first network node or a second network node.
